(19) United States
(12) Patent Application Publication
(10) Pub. No.: US 2010/0022152 A1
(43) Pub. Date: Jan. 28, 2010

(54) Method of recovering material and material recovering apparatus

(75) Inventors: Hiroshi Iwamoto, Osaka (JP); Yoshiyuki Tani, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Kadoma-shi, Osaka (JP)

(21) Appl. No.: 12/311,397

(22) PCT Filed: Sep. 26, 2007
(86) PCT No.: PCT/JP2007/068680

§ 371 Date: Mar. 27, 2009

(30) Foreign Application Priority Data
Sep. 29, 2006 (JP) 2006-267627
Aug. 31, 2007 (JP) 2007-225538
Aug. 31, 2007 (JP) 2007-225539

(51) Int. Cl. H01J 9/50

(52) U.S. Cl. 445/2; 445/61

(57) ABSTRACT

The present invention provides a material recovering method in which an attached member attached to at least one surface of a glass substrate is removed from the glass substrate so that the glass substrate is recovered. The method includes: a step A of crushing part of the glass substrate so that a glass fragment is formed; and a step B of allowing the glass fragment to impact against the attached member so as to detach and remove the attached member from the glass substrate. This method allows an attached member attached to a glass substrate to be removed at low cost and achieves an improved yield of the glass substrate.

### TECHNICAL FIELD

The present invention relates to a material recovering method and a material recovering apparatus that allow an attached member attached to a glass substrate to be removed from the glass substrate so as to recover the glass substrate. This invention particularly relates to a material recovering method and a material recovering apparatus for recovering a recyclable material such as a glass substrate from a display device including a glass substrate such as a plasma display panel.

### BACKGROUND ART

In recent years, display apparatuses suited for the trend toward a thinner and larger apparatus have been mass-manufactured, examples of which include a plasma display apparatus using a plasma display panel (hereinafter, referred to as a “PDP”) and a liquid crystal display apparatus using a liquid crystal display panel (hereinafter, referred to as a “LCD”). In the case where such apparatuses become unusable due to a defect, a malfunction, or the like, it is necessary that they be disassembled and recycled from the viewpoint of protecting the environment and of saving resources.

Display devices such as a PDP and a LCD as described above have a configuration in which thin-film or thick-film display members (attached members) have been formed to be attached to two glass substrates disposed opposite to each other, and a discharge gas or a liquid crystal member that is used for display is sealed into a gap between the two glass substrates.

For example, a PDP includes a front plate formed of a front glass substrate on which a display electrode, a dielectric layer, a protective layer made of magnesium oxide (MgO), and the like are formed, and a back plate formed of a back glass substrate on which an address electrode, a partition, a phosphor layer, and the like are formed. The PDP has a structure in which the front plate and the back plate are disposed opposite to each other in such a manner that a microscopic discharge space is formed between them, and the front glass substrate and the back glass substrate are attached hermetically to each other at their peripheral edge portions with a sealing member. Further, a discharge gas that is a mixture of neon (N3), xenon (Xe), and the like is sealed into the discharge space.

Furthermore, a LCD has a structure in which two glass substrates on which an electrode, a thin-film transistor, a polarizing film, a color filter, and the like are formed are disposed opposite to each other, and a liquid crystal member is sealed into a gap between the two glass substrates that then are attached hermetically to each other at their peripheral edge portions with a sealing member.

With regard to a PDP, conventionally, in most cases, defective products generated in a manufacturing process and used products collected from users due to a malfunction or the like, except for some of the products or any component of the products that is recyclable in the course of the process, are, for example, disassembled and then disposed of in landfills. However, in recent years, with the use of a PDP rapidly becoming widespread, there has been an increasing quantity of wastes. The increase in the quantity of waste leads to the occurrence of problems such as a shortage of landfill sites for waste disposal and deterioration of the Earth's environment. It therefore has been demanded that technologies for effectively recycling a PDP be developed.

In considering the recycling of a PDP, it is important that a front glass substrate and a back glass substrate that are main constituent materials of a PDP be recovered in a state of being approximate to a glass raw material. To this end, it is necessary that display members formed on the glass substrates, such as a dielectric layer, an electrode, a phosphor layer, and the like, be detached and removed in a state where the incorporation of any other material is prevented as much as possible.

There are various methods of detaching and removing a display member formed on a glass substrate.

Each of Patent Documents 1 and 2 discloses a method of detaching and removing a display member by mechanical grinding. In the method disclosed in each of Patent Documents 1 and 2, a PDP is separated into a front plate and a back plate, and a display member formed to be attached to a front glass substrate and a display member formed to be attached to a back glass substrate are ground away using an electrodeposition wheel to which a wheel-shaped grinding stone is fixed. The grinding stone is made of, for example, diamond or CBN (cubic boron nitride).
Patent Document 1: JP 2004-305900 A
Patent Document 2: JP 2005-334790 A

### DISCLOSURE OF INVENTION

### Problem to be Solved by the Invention

In order to recycle a large quantity of used display panels, it is necessary that a display member attached to a glass substrate be detached and removed efficiently at low cost.

The configuration disclosed in each of Patent Documents 1 and 2, in which a display member is ground mechanically using a grinding stone, results in a problem that, for example, due to a grinding life of the grinding stone, the number of times the grinding stone needs to be replaced with a new one increases or the grinding stone needs to be regenerated, leading to an increase in grinding cost.

Furthermore, the grinding treatment disclosed in each of Patent Documents 1 and 2 cannot be performed with respect to a glass substrate that is broken irregularly or pulverized, resulting in a problem that an increased quantity of glass substrates inevitably needs to be disposed of, leading to a decrease in yield.

It is an object of the present invention to provide a material recovering apparatus and a material recovering method that allow an attached member attached to a glass substrate to be removed at low cost, and achieve an improved yield of the glass substrate.

### Means for Solving Problem

A material recovering method according to the present invention is a material recovering method in which an attached member attached to at least one surface of a glass substrate is removed from the glass substrate so that the glass substrate is recovered. The method includes: a step A of crushing part of the glass substrate so that a glass fragment is formed; and a step B of allowing the glass fragment to impact against the attached member so as to detach and remove the attached member from the glass substrate.

A material recovering apparatus according to the present invention is a material recovering apparatus that removes an attached member attached to at least one surface of a glass substrate from the glass substrate so as to recover the glass substrate. The apparatus includes: a housing with a side surface provided with a plurality of through holes, which can house the glass substrate; and a blasting device that is capable of performing a blasting treatment with respect to both surfaces of the glass substrate through the plurality of through holes of the housing.

### EFFECTS OF THE INVENTION

According to the present invention, an attached member attached to a glass substrate can be removed at low cost. Further, when recycling a glass substrate, an improved yield can be obtained.

### BRIEF DESCRIPTION OF DRAWINGS

FIG. 1A is a plan view showing a configuration of a display device.

FIG. 1B is a cross-sectional view taken along line Z-Z of FIG. 1A.

FIG. 2 is a perspective view showing a main portion of the display device.

FIG. 3 is a flow chart showing a flow of a material recovering method according to Embodiment 1.

FIG. 4A is a plan view showing a configuration of the display device before being divided.

FIG. 4B is a plan view showing a configuration of the display device that has been divided.

FIG. 4C is a cross-sectional view taken along line Y-Y of FIG.4B.

FIG. 5 is a schematic diagram for explaining an operation of detaching and removing a display member.

FIG. 6 is a flow chart showing a flow of a material recovering method according to Embodiment 2.

FIG. 7 is a flow chart showing a flow of a material recovering method according to Embodiment 3.

FIG. 8 is a schematic diagram showing a configuration of a material recovering apparatus according to Embodiment 3.

FIG. 9 is a schematic diagram showing, as another example, a configuration of the material recovering apparatus according to Embodiment 3.

FIG. 10 is a schematic diagram showing a configuration of a blasting device.

FIG. 11A is a side view showing a configuration of a housing.

FIG. 11B is a cross-sectional view taken along line X-X of FIG. 11A.

FIG. 12 is a flow chart showing a flow of a material recovering method according to Embodiment 4.

FIG. 13A is a schematic diagram showing a configuration of a material recovering apparatus according to Embodiment 4.

FIG. 13B is a schematic diagram showing a configuration of the material recovering apparatus as seen from a direction indicated by an arrow K in FIG. 13A.

FIG. 14 is a schematic diagram showing, as another example, a configuration of the material recovering apparatus according to Embodiment 4.

FIG. 15 is a flow chart showing a flow of a material recovering method according to Embodiment 5.

FIG. 16 is a schematic diagram showing a configuration of a material recovering apparatus according to Embodiment 5.

FIG. 17 is a flow chart showing a flow of an attached member-removing method according to Embodiment 5.

### EXPLANATION OF LETTERS OR NUMERALS

1 PDP

10 front plate

11 front glass substrate

12 scanning electrode

13 sustain electrode

14 display electrode

15 light-blocking layer

16 dielectric layer

17 protective layer

18 front plate display member

20 back plate

21 back glass substrate

22 address electrode

23 base dielectric layer

24 partition

25 phosphor layer

26 discharge space

27 sealing portion

28 back plate display member

31 first region member

32a, 32b, 32c, 32d second region member

40 glass fragment

41 blasting device

42 conveyor portion

43 blasting nozzle

### DESCRIPTION OF THE INVENTION

A first material recovering method according to the present invention is a material recovering method of recovering a front glass substrate and a back glass substrate from a display device including: a front plate formed of the front glass substrate on which a front plate display member is formed; and a back plate formed of the back glass substrate on which a back plate display member is formed, in which the front plate and the back plate are disposed opposite to each other, and peripheries of the front plate and the back plate are sealed hermetically with a sealing member so that a discharge space is formed. The method includes: a step A of crushing a predetermined region of the glass substrates so that a glass fragment is formed; and a step B of allowing the glass fragment to impact against at least one of the front plate display member and the back plate display member so as to detach and remove the front plate display member from the front glass substrate or so as to detach and remove the back plate display member from the back glass substrate. This method uses no mechanical grinding means or the like and utilizes only a material constituting a display device, thereby allowing a material to be recovered at low cost while preventing the incorporation of any other substance.

The first material recovering method according to the present invention can be a method further including: a step C of dividing the display device into a first region member that includes the discharge space and a second region member that is other than the first region member, in which in the step A, the second region member is crushed so that a glass fragment is formed. According to this method, a front plate display member and a back plate display member, which are formed on a plate-shaped front glass substrate and a plate-shaped back glass substrate, respectively, can be detached and removed efficiently, thereby allowing materials of the front glass substrate and the back glass substrate to be recovered efficiently.

The first material recovering method according to the present invention can be a method further including: a step D of crushing the first region member so that a glass substrate fragment is formed, in which in the step B, the glass fragment formed in the step A and the glass substrate fragment formed in the step D are allowed to impact against each other so as to detach and remove the display members attached to the glass substrate fragment from the glass substrate fragment. According to this method, even in the case of a display device such as a used display device, in which a front glass substrate and a back glass substrate are broken and thus cannot be ground with mechanical grinding means, a front plate display member and a back plate display member can be detached and removed, thereby allowing a material to be recovered.

The first material recovering method according to the present invention can be a method further including: a step E of recovering a metal contained in the front plate display member or the back plate display member, in which the step E is performed subsequent to the step B. According to this method, a noble metal or the like can be recovered and recycled from a material component containing no other impurities than a substance used in a display device.

A second material recovering method according to the present invention is a material recovering method in which an attached member attached to at least one surface of a glass substrate is removed from the glass substrate so that the glass substrate is recovered. The method includes: a step F of housing the glass substrate in a housing with a side surface provided with a plurality of through holes; and a step G of performing a blasting treatment with respect to both surfaces of the glass substrate through the plurality of through holes of the housing. According to this method, since blasting is performed from both of a front surface and a rear surface of a glass substrate, a thin film member and a thick film member can be detached and removed from both of the front surface and the rear surface at one time, thereby allowing the glass substrate alone to be recovered with high productivity.

In the second material recovering method according to the present invention, a configuration is possible in which the housing is disposed at a slant with respect to a perpendicular direction, and a blast pressure used for a blasting treatment performed from a lower side of a slanting surface of the housing is set to be higher than a blast pressure used for a blasting treatment performed from an upper side of the slanting surface. According to this method, since a housing is slanted, it is possible to perform a blasting treatment while allowing a display member-attached glass substrate in the housing to fall, and thus a consecutive treatment can be performed. Further, in that case, since a blast pressure applied from the lower side is set to be higher than a blast pressure applied from the upper side, it is possible to allow a display member-attached glass substrate housed in the housing to fall in a floating state, and thus a consecutive treatment can be performed reliably.

In the second material recovering method according to the present invention, a configuration is possible in which the housing is provided in such a manner as to stand in a perpendicular direction. According to this method, after a predetermined quantity of display member-attached glass substrates are housed in a housing, a blasting treatment can be performed efficiently from both surfaces of each of the display member-attached glass substrates.

In the second material recovering method according to the present invention, a configuration is possible in which the housing is formed of at least two plate bodies, in each of which a plurality of through holes are formed, and that are disposed opposite to each other via a gap, and the gap is formed so as to be wider than a thickness of the glass substrate and narrower than twice the thickness of the glass substrate. According to this method, it is possible to detach and remove an attached member attached to a glass substrate reliably while preventing overlapping of display member-attached glass substrates in a gap.

The second material recovering method according to the present invention can be a method in which in the step G, at least one of the housing and the glass substrate housed in the housing is swung. According to this method, when performing a blasting treatment, the blasting treatment can be performed with respect to an entire surface of a display member-attached glass substrate without being affected by a frame that forms through holes of plate bodies constituting a housing, and thus detachment and removal can be performed efficiently.

A first material recovering apparatus according to the present invention is a material recovering apparatus that removes an attached member attached to at least one surface of a glass substrate from the glass substrate so as to recover the glass substrate. The apparatus includes: a housing with a side surface provided with a plurality of through holes, which can house the glass substrate; and a blasting device that is capable of performing a blasting treatment with respect to both surfaces of the glass substrate through the plurality of through holes of the housing. According to this configuration, since blasting is performed from both of a front surface and a rear surface of a glass substrate, a thin film member and a thick film member can be detached and removed from both of the front surface and the rear surface at one time, and thus a glass substrate recovering apparatus can be provided that recovers a glass substrate alone with high productivity.

The first material recovering apparatus according to the present invention can have a configuration in which the housing has a slanting surface that extends from a side from which the housing houses the glass substrate to a side on which the blasting treatment is performed. According to this configuration, since a housing is slanted, it is possible to perform a blasting treatment while allowing a display member-attached glass substrate in the housing to fall, and thus a consecutive treatment can be performed.

The first material recovering apparatus according to the present invention can have a configuration in which the housing is formed of at least two plate bodies, in each of which a plurality of through holes are formed, and that are disposed opposite to each other via a gap, and the gap is formed so as to be wider than a thickness of the glass substrate and narrower than twice the thickness of the glass substrate. According to this configuration, it is possible to detach and remove an attached member attached to a glass substrates reliably while preventing overlapping of display member-attached glass substrates in a gap.

The first material recovering apparatus according to the present invention can have a configuration in which the apparatus further includes a swinging device that swings at least one of the housing and the glass substrate housed in the housing. According to this configuration, when performing a blasting treatment, the blasting treatment can be performed with respect to an entire surface of a display member-attached glass substrate without being affected by a frame that forms through holes of plate bodies constituting a housing, and thus detachment and removal can be performed efficiently.

A third material recovering method according to the present invention is a material recovering method in which an attached member attached to at least one surface of a glass substrate is removed from the glass substrate so that the glass substrate is recovered. The method includes: a step H of arranging the glass substrate in a single layer on a substrate-mounting stage; a step I of performing a blasting treatment with respect to one surface of the glass substrate; a step J of, subsequent to the step I, turning over the glass substrate and arranging the glass substrate in a single layer on the substrate-mounting stage; and a step K of, subsequent to the step J, performing a blasting treatment with respect to the other surface of the glass substrate. According to this surface removal method, regardless of whether an attached member is formed on a front surface or on a rear surface of a substrate, since the substrate is arranged in a single layer on a substrate-mounting stage, the following can be performed. That is, in a first detachment and removal step, an attached member can be removed from each substrate with the attached member exposed on one surface thereof, and after the substrates are turned over, further in a second detachment and removal step, an attached member can be removed from each glass substrate with the attached member exposed on the other surface thereof. Thus, even in the case where glass substrates mounted on a substrate-mounting stage are not necessarily facing the same direction, it is possible to detach and remove an attached member from each of all the substrates reliably, thereby allowing a substrate such as a glass substrate alone to be recovered efficiently.

In the third material recovering method according to the present invention, preferably, each of the step I and the step K is a step in which a blasting treatment is performed with respect to the glass substrate from a side of one of the surfaces of the glass substrate so as to detach and remove the attached member attached to the glass substrate. According to this method, even in the case where a broken substrate of an irregular shape is mounted on a substrate-mounting stage, it is possible to detach and remove an attached member formed on a surface of the substrate reliably and efficiently.

In the third material recovering method according to the present invention, preferably, the step H is a step of mounting the glass substrate on a first substrate-mounting stage, and the step J is a step of mounting the glass substrate on a second substrate-mounting stage. According to this method, it is possible to perform detachment and removal consecutively, thereby allowing surface removal to be performed with high productivity.

A second material recovering apparatus according to the present invention is a material recovering apparatus that removes an attached member attached to at least one surface of a glass substrate from the glass substrate so as to recover the glass substrate. The apparatus includes: a substrate-mounting stage on which the glass substrate is mounted in a single layer; a blasting device that performs a blasting treatment with respect to the glass substrate mounted on the substrate-mounting stage from a side of one of surfaces of the glass substrate; and a turning-over mechanism that turns over the glass substrate mounted on the substrate-mounting stage. After the blasting device has performed the blasting treatment with respect to one surface of the glass substrate, the turning-over mechanism turns over the glass substrate so that the blasting treatment can be performed with respect to the other surface of the glass substrate. According to this configuration, regardless of whether an attached member is formed on a front surface or a rear surface of a substrate, the following can be performed. That is, substrates are arranged in a single layer on a substrate-mounting stage, and a grinding material is sprayed on surfaces of the substrates by a grinding material injector so that an attached member is removed from each substrate with the attached member exposed thereon, and further, after the substrates are turned over, an attached member is removed from each glass substrate with the attached member exposed on the other surface thereof. Thus, even in the case where glass substrates mounted on a substrate-mounting stage are not necessarily facing the same direction, it is possible to detach and remove an attached member from each of all the glass substrates reliably, thereby allowing a substrate such as a glass substrate alone to be recovered efficiently.

The second material recovering apparatus according to the present invention can have a configuration in which the substrate-mounting stage includes: a first substrate-mounting stage including a first blasting device; a second substrate-mounting stage including a second blasting device; and a conveyor portion that is capable of conveying the glass substrate from the first substrate-mounting stage to the second substrate-mounting stage, and the turning-over mechanism is provided between the first substrate-mounting stage and the second substrate-mounting stage. According to this configuration, it is possible to perform detachment and removal consecutively, thereby allowing surface removal to be performed with high productivity.

The second material recovering apparatus according to the present invention can have a configuration in which the turning-over mechanism includes: a first plate body on which the glass substrate conveyed from the first substrate-mounting stage is mounted; a second plate body that is disposed opposite to the first plate body; a clamping mechanism that holds the glass substrate by sandwiching the glass substrate between the first plate body and the second plate body; and a turning-over portion that reverses a position of the first plate body and a position of the second plate body, while the glass substrate is held by the clamping mechanism. According to this configuration, with respect to glass substrates that are not facing the same direction, it is possible to hold the glass substrates reliably by sandwiching them between a first plate body and a second plate body and turn them over, and thus an attached member can be detached and removed from each of all the glass substrates reliably, thereby allowing a substrate such as a glass substrate alone to be recovered efficiently.

### Embodiment 1

[1. Configuration of Display Device]

The material recovering apparatus and material recovering method according to the present invention are characterized mainly in that an attached member attached to a glass substrate included in a display device is removed at low cost and efficiently. Examples of a display device include a PDP (plasma display panel) and a LCD liquid crystal display), and a PDP is used as an example in describing embodiments of the present invention. Accordingly, each of the embodiments of the present invention describes an apparatus and a method that allow an attached member such as a display member, which is attached to a glass substrate included in a PDP, to be removed.

The description is directed first to respective definitions of terms used in each of the embodiments of the present invention. A “display device” refers to a PDP or a LCD. Each of a “front plate” and a “back plate” includes a glass substrate and an attached member attached to the glass substrate. A “front glass substrate” and a “back glass substrate” refer to glass substrates themselves included in the front plate and the back plate, respectively. A “glass substrate” is used to generically refer to the front glass substrate and the back glass substrate. A “glass substrate fragment” is obtained by crushing the glass substrate with a crusher and is coarser compared with a glass fragment that will be described later. A “glass fragment” is obtained by crushing the glass substrate with a crusher and is finer compared with the above-described glass substrate fragment. A “glass powder” has a particle diameter equal to that of the glass fragment and can be assumed to be subsumed under the definition of the glass fragment.

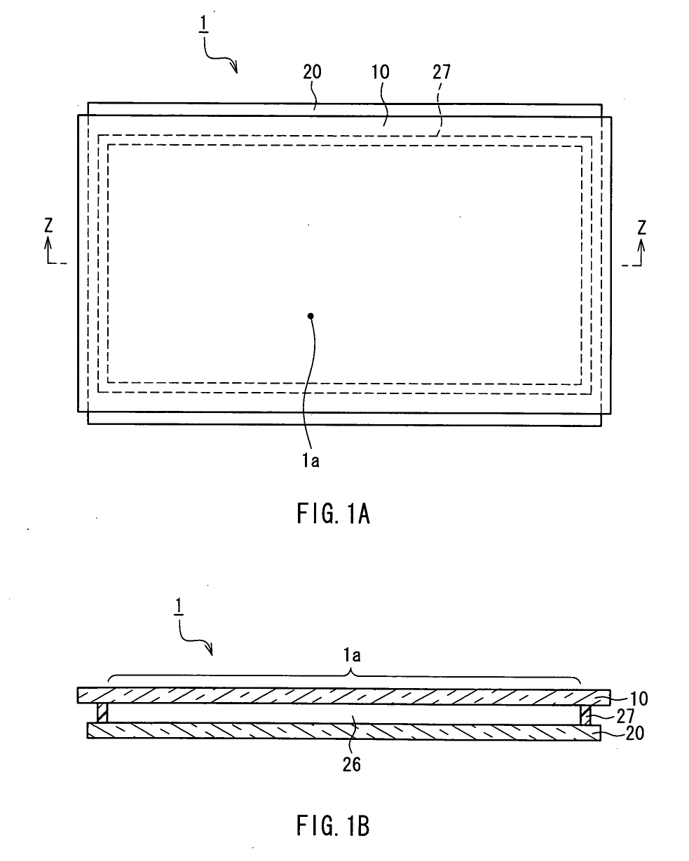

FIG. 1A is a plan view showing a basic structure of a PDP as seen from a front surface side of the PDP (a surface side on which a displayed video image can be viewed from the exterior). FIG. 1B shows a cross section taken along line Z-Z of FIG. 1A, in which depiction of a detailed configuration of each display member or the like is omitted. The basic structure of the PDP used in this embodiment is similar to that of an alternate current surface discharge-type PDP that is a representative example of an AC type PDP.

As shown in FIGS. 1A and 1B, a PDP 1 includes a front plate 10 and a back plate 20. As shown in FIG. 1B, the front plate 10 and the back plate 20 are disposed in such a manner that respective principal planes thereof are opposed in parallel to each other via a microscopic discharge space 26. Further, at their opposed principal planes, the front plate 10 and the back plate 20 are attached hermetically to each other with a sealing portion 27. As shown in FIG. 1, the sealing portion 27 is disposed in such a manner as to surround a display region 1a of the PDP 1 on a projection plane.

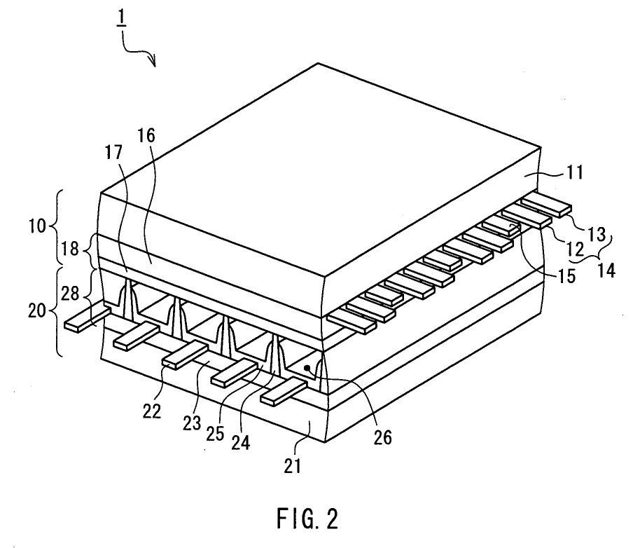

FIG. 2 is a perspective view showing a main portion obtained by rupturing part of the display region 1a of the PDP 1. The front plate 10 includes a front glass substrate 11, a display electrode 14 composed of a scanning electrode 12 and a sustain electrode 13, and a light-blocking layer 15. Further, the back plate 20 includes a back glass substrate 21, an address electrode 22, a base dielectric layer 23, a partition 24, and a phosphor layer 25.

On one principal plane of the front glass substrate 11, the display electrode 14 is provided, and an image displayed by the display electrode 14 can be viewed from a side of the other principal plane of the front glass substrate 11. As the display electrodes 14, a plurality of electrode pairs, each composed of the scanning electrode 12 and the sustain electrode 13, are provided parallel to one another in a plane direction of the front glass substrate 11. The light-blocking layer 15 is formed between each pair of adjacent ones of the display electrodes 14 to separate them so that light emitted from one of the display electrodes 14 is prevented from leaking to the side of another one of the display electrodes adjacent thereto. A dielectric layer 16 is formed on the front glass substrate 11 in such a manner as to cover the display electrodes 14 and functions as a capacitor. A protective layer 17 is formed on the dielectric layer 16 and is made of a material containing magnesium oxide (MgO) as a main component.

The address electrode 22 and the base dielectric layer 23 are formed on one principal plane of the back glass substrate 21. The address electrode 22 is formed in stripes with respect to a plane direction of the principal plane of the back glass substrate 21. The base dielectric layer 23 is formed in such a manner as to cover the address electrodes 22. The partition 24 is formed on the base dielectric layer 23. The partition 24 is formed in a direction parallel to the address electrodes 22 so as to optically separate the address electrodes 22 from one another. The phosphor layer 25 is formed between each pair of adjacent ones of the partitions 24 and is made of any one of materials that emit light of a red color (R), a green color (G), and a blue color (B), respectively.

As shown in FIG. 2, the front plate 10 and the back plate 20 are disposed opposite to each other via the microscopic discharge space 26 in such a manner that the display electrodes 14 and the address electrodes 22 are orthogonal to each other on the projection plane. The discharge space 26 is formed in the display region 1a of the PDP 1. Peripheral edge portions of the display region 1a of the PDP 1 are sealed hermetically with the sealing portion 27. Generally, glass frit is used for the sealing portion 27. Further, a discharge gas is sealed into the discharge space 26 under a predetermined pressure. The discharge gas is made of, for example, a mixed gas of neon (Ne) and xenon (Xe). Further, the discharge gas is sealed into the discharge space 26 under a pressure of, for example, 53 to 80 kPa. Further, the discharge space 26 is partitioned by the partitions 24. One discharge cell is composed of part of the discharge space 26 obtained by partitioning, the phosphor layer 25, and an area of intersection between the display electrode 14 and the address electrode 22. Further, one pixel is composed of adjacent discharge cells of three colors (R, G, and B).

In order for a video image to be displayed on the PDP 1 of the above-described configuration, a voltage based on a video signal is applied selectively to the display electrode 14. The application of a voltage to the display electrode 14 causes discharging of the discharge gas sealed into the discharge space 26, so that plasma is generated. At the time of plasma generation, ultraviolet radiation is generated and excites the phosphor layer 25, so that the phosphor layer 25 emits a beam of visible light of either a red color, a green color, or a blue color. A voltage to be applied to the display electrode 14 is controlled so that the generation and disappearance of plasma in the discharge space 26 is controlled, and thus a display of a color image can be performed.

The description is directed next to a method of manufacturing a PDP and materials of the PDP.

When manufacturing a PDP, first, the scanning electrode 12, the sustain electrode 13, and the light-blocking layer 15 are formed on the front glass substrate 11. The front glass substrate 11 is made of, for example, sodium borosilicate glass formed by a float method. The scanning electrode 12 and the sustain electrode 13 are formed of a transparent electrode (not shown) and a metal bus electrode (not shown), respectively. The transparent electrode is made of indium tin oxide (ITO), tin oxide (SnO₂), or the like. The metal bus electrode is formed of a conductive material that contains a silver (Ag) material as a main component and is formed on a transparent electrode. The transparent electrode is formed using, for example, a thin film process. The metal bus electrode is formed by calcining a paste containing a glass material on a silver (Ag) material at a predetermined temperature and solidifying it. Further, the light-blocking layer 15 is formed by a method in which a paste containing a glass material is screen-printed on a black pigment or a method in which after a black pigment is formed on an entire surface of the front glass substrate 11, patterning is performed using a photolithographic method, followed by calcining.

Next, the dielectric layer 16 is formed on the front glass substrate 11. Specifically, a dielectric paste is applied onto the front glass substrate 11 by a die coating method or the like, and thus a dielectric paste layer (dielectric material layer) is formed. At this time, the dielectric paste layer is formed in such a manner as to cover the scanning electrodes 12, the sustain electrodes 13, and the light-blocking layers 15. The dielectric paste that has been applied is allowed to stand for a predetermined period of time, and thus a surface of the applied dielectric paste is leveled to be flattened. After that, the dielectric paste layer is calcined and solidified, and thus the dielectric layer 16 is formed that covers the scanning electrodes 12, the sustain electrodes 13, and the light-blocking layers 15. The dielectric paste is made of a paint containing a dielectric material such as a glass powder, a binder, and a solvent.

Next, on the dielectric layer 16, the protective layer 17 made of magnesium oxide (MgO) is formed by a vacuum deposition method.

By following the above-described steps, a predetermined front plate display member 18 (the scanning electrode 12, the sustain electrode 13, the light-blocking layer 15, the dielectric layer 16, the protective layer 17) is formed on the front glass substrate 11, and thus the front plate 10 is completed.

The description is directed next to a method of forming the back plate 20.

First, the address electrode 22 is formed on the back glass substrate 21. Specifically, a material layer is formed on the back glass substrate 21 by, for example, a method in which a paste containing a glass material is screen-printed on a silver (Ag) material or a method in which after a metal film is formed on an entire surface, patterning is performed using the photolithographic method. Next, the material layer is calcined at a predetermined temperature, ant thus the address electrode 22 can be formed.

Next, the base dielectric layer 23 is formed. Specifically, a dielectric paste is applied by the die coating method or the like onto the back glass substrate 21 on which the address electrodes 22 have been formed, and thus a dielectric paste layer is formed. At this time, the dielectric paste is applied in such a manner as to cover the address electrodes 22. After that, the dielectric paste layer is calcined, and thus the base dielectric layer 23 can be formed. The dielectric paste is made of a paint containing a dielectric material such as a glass powder, a binder, and a solvent.

Next, the partition 24 is formed. Specifically, a paste for forming a partition is applied onto the base dielectric layer 23 and patterned into a predetermined shape, and thus a partition material layer is formed. Next, the partition material layer is calcined, and thus the partition 24 is formed. The paste for forming a partition contains partition materials such as a glass material, an aggregate, and the like. As a method of patterning the paste for a partition, the photolithographic method and a sand blasting method can be used.

Next, the phosphor layer 25 is formed. Specifically, a phosphor paste containing a phosphor material is applied onto a portion of the base dielectric layer 23 located between each pair of adjacent ones of the partitions 24 and to side surfaces of the each pair of the partitions 24. Next, the phosphor paste is calcined, and thus the phosphor layer 25 is formed. Among the types of the phosphor layer 25, a red phosphor layer can be made of a phosphor material powder body of Y₂ₓO₃:Eux or (Y, Gd)₁₋ₓBO₃:Euₓ. Further, a green phosphor layer can be made of a phosphor material powder body of [(Zn₁₋ₓMnₓ)₂SiO₄]. Further, a blue phosphor layer can be made of a phosphor material powder body of Ba₁₋ₓMgAl₁₀O₁₇:Euₓ or Ba_{1-x-y}Sr_{y}MgAl₁₀O₁₇:Euₓ. Each of these material powder bodies is used as a paste and applied to an area between each pair of adjacent ones of the partitions 24 by a printing method, an ink-jet method, or the like. Next, each of the material powder bodies is dried and then calcined, and thus the phosphor layer 25 of each of the respective colors is formed.

By following the above-described steps, the back plate 20 on which a predetermined back plate display member 28 (the address electrode 22, the base dielectric layer 23, the partition 24, the phosphor layer 25) is formed is completed.

Next, the front plate 10 including the front plate display member 18 and the back plate 20 including the back plate display member 28 are disposed opposite to each other in such a manner that the scanning electrodes 12 and the address electrodes 22 are orthogonal to each other on the projection plane, and the sealing portion 27 provided on the periphery of the front plate 10 and the back plate 20 is sealed hermetically with a sealing member. The sealing member is made of, for example, glass frit having a low melting point. Next, a discharge gas is sealed into the discharge space 26. By following these steps, the PDP 1 is completed.

[2. Material Recovering Method]

The PDP 1 has a configuration in which the display members (except for the phosphor layer 25) having predetermined material compositions including a glass component are attached tightly to the front glass substrate 11 or the back glass substrate 21. Therefore, the detachment and removal of these display members require a substantial amount of detaching force to be exerted at an interface at which each of the display members is attached tightly.

The method of recovering a material of a PDP according to this embodiment is a method used suitably for recovering a material from a PDP in a state of, for example, not being damaged or broken.

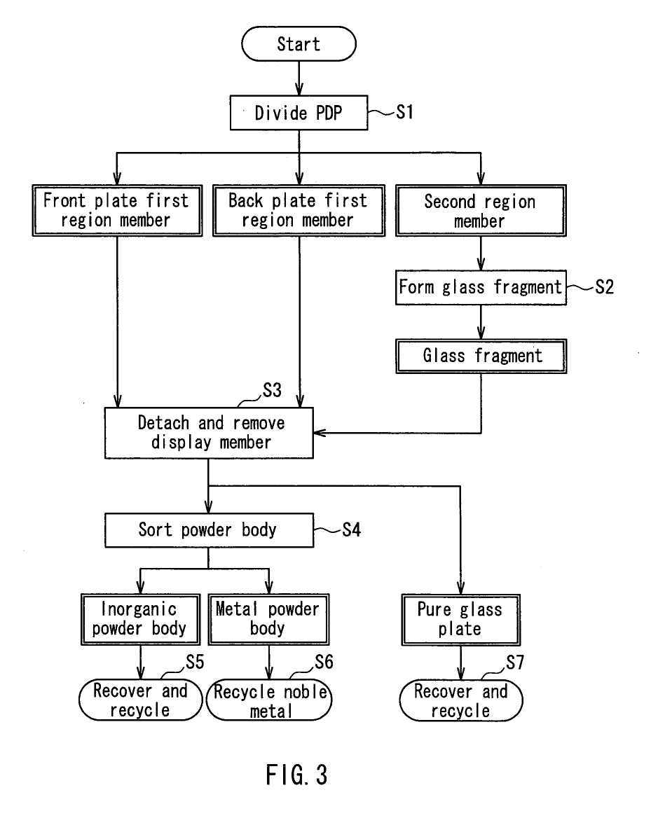

FIG. 3 shows a flow of the material recovering method according to Embodiment 1. The following describes the material recovering method according to this embodiment.

First, a PDP is divided (S1). As described above, in the PDP, the front plate 10 and the back plate 20 are attached hermetically to each other at their outer peripheral portions with the sealing portion 27, and therefore, it is necessary for the front plate 10 and the back plate 20 to be separated from each other. In S1, the PDP 1 is cut at predetermined positions so as to be divided into six members that are a front plate first region member 33, a back plate first region member 34, and second region members 32a, 32b, 32c, and 32d. A specific dividing method will be described later.

Next, the second region members 32a, 32b, 32c, and 32d are fragmented into glass fragments in the step of forming glass fragments (S2). Specifically, the second region members 32a, 32b, 32c, and 32d are pulverized with a pulverizer, and thus glass fragments having a particle diameter of several tens of μm to several thousands of μm are formed.

Next, the glass fragments are ejected at a high speed by a blasting device so as to impact against the front plate first region member 33 and the back plate first region member 34, and an impact force generated at that time is used to detach and remove display members attached to the front plate first region member 33 and the back plate first region member 34 (S3), thereby allowing a pure glass plate to be obtained. A specific detachment and removal method will be described alter.

Next, the glass fragments used for detachment and removal of the front plate display member 18 and the back plate display member 28 as well as glass fragments (the dielectric layer 16, the light-blocking layer 15, the partition 24, the base dielectric layer 23, etc.) and metal fragments (the display electrode 14, the address electrode 22) that are generated in the process of detaching and removing the front plate display member 18 and the back plate display member 28 are collected and treated to be sorted (S4). Specifically, the glass fragments and the metal fragments are sorted into an inorganic powder body and a metal powder body by a specific gravity separation method, an electrostatic separation method, or the like. The inorganic powder body includes the glass fragments that have provided the impact force used for detaching and removing the front plate display member 18 and the back plate display member 28 by the blasting device, and a glass component contained in, for example, the dielectric layer 16 included in the front plate display member 18 and the base dielectric layer 23 included in the back plate display member 28. The metal powder body includes silver, tin, indium, or the like that mainly constitutes, for example, the scanning electrode 12 and the sustain electrode 13 included in the front plate display member 18 and the address electrode included in the back plate display member 28.

The inorganic powder body can be recycled by being sifted through a sieve so as to be used as a grinding material for a blasting device or by being recovered into a glass component material (S5). Further, the metal powder body can be recycled by being subjected to an electrolysis technique or the like so that a noble metal is recovered (S6).

Needless to say, a pure glass substrate obtained by detaching and removing the display members also can be recovered so as to be recycled (S7).

The following describes a method of dividing the PDP 1.

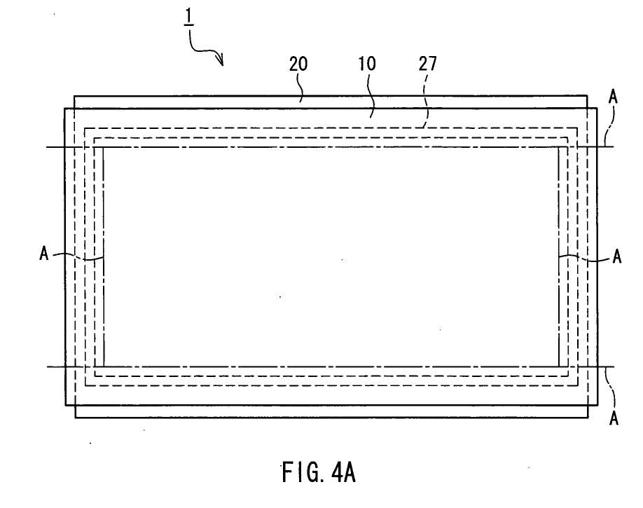

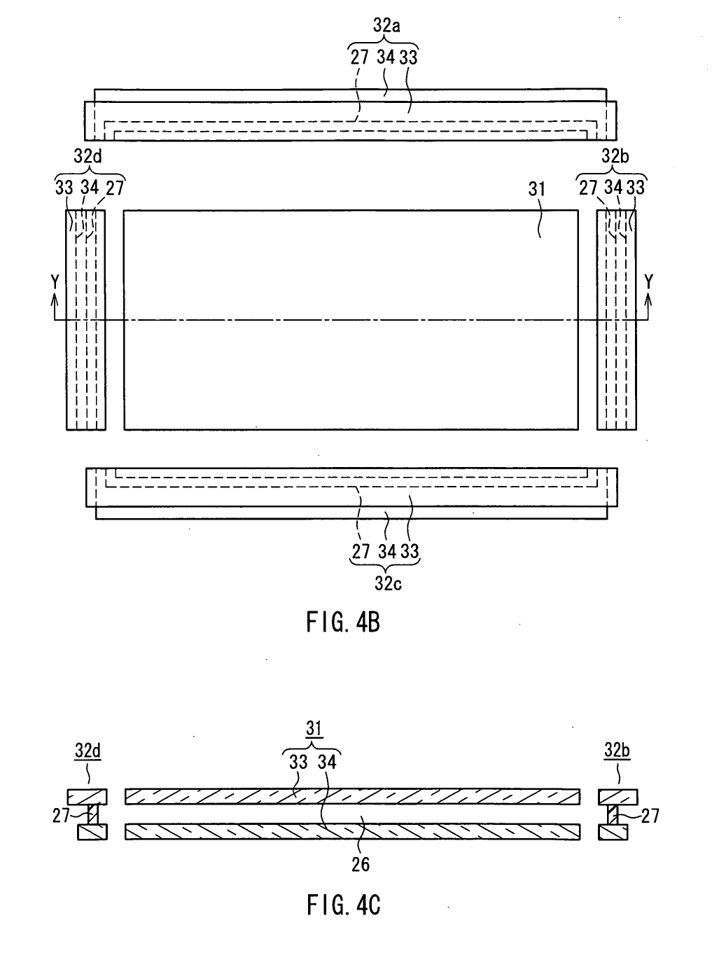

FIG. 4A shows the PDP 1 before being subjected to a dividing treatment. In the PDP 1 shown in FIG. 4A, a cutting treatment is performed at each portion indicated by an alternate long and short dashed line A. The alternate long and short dashed line A is a line substantially parallel to the side of the display region 1a relative to the sealing portion 27 (hereinafter, referred to as an “inner surface”). Examples of a method of cutting the PDP 1 include a method in which a cutter wheel, a diamond cutter, a water jet, an energized wire, or the like is brought into contact with a glass substrate to cut the glass substrate or a method in which a glass substrate is irradiated with laser light so as to be cut due to heat generated thereby. FIGS. 4B and 4C show the PDP 1 after being subjected to the cutting treatment. FIG. 4C shows a cross section taken along line Y-Y of FIG. 4B. As shown in FIGS. 4B and 4C, in S1 shown in FIG. 3, the PDP 1 is divided into a first region member 31 and the second region members 32a, 32b, 32c, and 32d. As shown in FIG. 4B, the first region member 31 corresponds to a portion inside the sealing portion 27. Further, as shown in FIG. 4B, the second region members 32a, 32b, 32c, and 32d are members on the periphery of the first region member 31 and include the sealing portion 27. The first region member 31 can be divided into the front plate first region member 33 including the front glass substrate 11 of the front plate 10, which is provided with the front plate display member 18, and the back plate first region member 34 including the back glass substrate 21 of the back plate 20, which is provided with the back plate display member 28. Further, the second region members 32a, 32b, 32c, and 32d include sealing glass contained in a sealing member attached to the sealing portion 27 of the front glass substrate 11 and the back glass substrate 21, an electrode terminal member formed at an end portion of each of the front plate 10 and the back plate 20, and the like.

[2-1. Method of Detaching and Removing Display Member]

The description is directed next to a method of detaching and removing the front plate display member 18 from the front plate first region member 33 and a method of detaching and removing the back plate display member 28 from the back plate first region member 34.

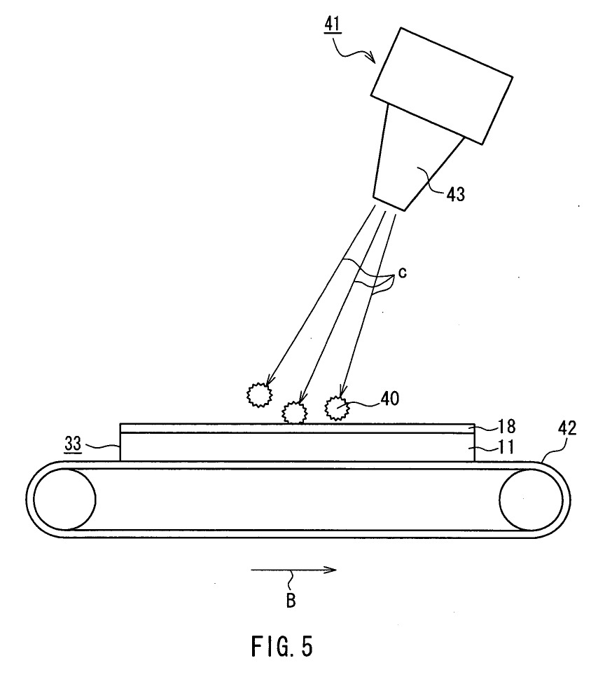

FIG. 5 schematically shows an attached member-removing apparatus according to Embodiment 1. The attached member-removing apparatus is composed mainly of a blasting device 41 and a conveyor portion 42. The blasting device 41 is capable of expelling a glass fragment 40 having a predetermined particle size at a high speed. The blasting device 41 includes a supply unit (not shown) that supplies a grinding material such as the glass fragment 40 and a pneumatic pressurizing unit (not shown) that expels a grinding material such as the glass fragment 40 at a high speed from a blasting nozzle 43. The conveyor portion 42 is capable of mounting the front plate first region member 33 or the back plate first region member 34 thereon and conveying it in a direction indicated by an arrow B. FIG. 5 shows a state where the front plate first region member 33 is mounted on the conveyor portion 42, exemplifying a case where the front plate first region member 33 is mounted on the conveyor portion 42.

First, the front glass substrate 11 on which the front plate display member 18 is formed is mounted on the conveyor portion 42, with a side of the front plate display member 18 thereof facing up.

Next, the blasting device 41 ejects the glass fragment 40 formed by crushing the above-described second region members 32a, 32b, 32c, and 32d from the blasting nozzle 43 at a high speed in a direction indicated by each of arrows C toward a surface of the front plate display member 18. The glass fragment 40 ejected from the blasting nozzle 43 impacts against the front plate display member 18 and thus is capable of, using an impact force generated at that time, detaching and removing the front plate display member 18 from the first region member 31. At this time, it is only required that an impact force of the glass fragment 40 ejected from the blasting nozzle 43 with respect to the front plate display member 18 be large enough to at least allow the front plate display member 18 to be detached and removed from the first region member 31. While the conveyor portion 42 is moved toward the direction indicated by the arrow B, the blasting nozzle 43 is swung so that an injection direction is varied, and thus the glass fragment 40 is allowed to impact against an entire region of the front plate display member 18 and an angle of impact is controlled.

In this embodiment, as the glass fragment 40, a glass fragment formed by crushing the second region members 32a, 32b, 32c, and 32d is used. Since as described above, glass of the front glass substrate 11 and glass of the back glass substrate 21 are sealed hermetically with the sealing material 27, the main component of the second region members 32a, 32b, 32c, and 32d have a hardness equal to or higher than a hardness of, for example, a material constituting the dielectric layer 16 included in the front plate display member 18. The second region members 32a, 32b, 32c, and 32d are set to have a hardness not lower than a hardness of the front plate display member 18, and thus even without increasing an ejection force of the blasting nozzle 43, an impact force with respect to the front plate display member 18 can be increased. Therefore, by controlling an impacting speed and an impacting angle of the glass fragment 40 by means of, for example, an operation condition of the blasting device 41 and a distance between the blasting nozzle 43 and the front plate display member 18, and by controlling a particle size distribution of the glass fragment 40, the front plate display member 18 formed on the front glass substrate 11 can be detached and removed with accuracy.

A detachment and removal treatment is performed in the above-described manner, and thus an attached member such as the front plate display member 18 can be detached and removed from the first region member 31 in a plate shape, and the front glass substrate 11 alone, which is a constituent material of the first region member 31, can be recovered. As described above, the glass fragments are of the same glass component as that of the front glass substrate 11, and thus there is no need to remove the glass fragments from the front glass substrate 11 before the front glass substrate 11 that has been recovered is remelted. Therefore, for example, when the front glass substrate 11 that has been recovered is remelted so as to be recycled, handling of the glass substrate is facilitated, thereby allowing improved recycling efficiency to be obtained.

Although the above description has been directed to the method of detaching and removing the front plate display member 18 included in the front plate first region member 33, also in the case of detaching and removing the back plate display member 28 included in the back plate first region member 34, it can be detached and removed with efficiency and accuracy by a similar method.

[3. Effect of Embodiment, etc.]

This embodiment has a configuration in which the glass fragment 40 is formed by crushing the second region members 32a, 32b, 32c, and 32d, and the glass fragment 40 thus obtained is allowed to impact against the first region member 31 so as to remove an attached member such as a display member, and thus a detachment and removal treatment is performed utilizing only a member constituting the PDP 1, thereby allowing the attached member to be detached and removed at low cost.

Furthermore, no mechanical grinding means such as a grinding stone is used for the detachment and removal of a display member, and thus there is no need for a cost of preparing grinding means and a cost of managing grinding means (such as for periodic maintenance of a grinding stone), thereby allowing a grinding cost to be reduced.

Furthermore, in this embodiment, only a substance constituting the PDP 1 is used in the process of a material recovering treatment, and thus the incorporation of any other substance is prevented, thereby facilitating quality maintenance of a material to be recovered.

Furthermore, in this embodiment, an attached member attached to a glass substrate is removed by a dry treatment that does not use a solution or the like, and thus a process step control can be facilitated. That is, there is no need to, for example, clean a glass substrate and a detachment and removal apparatus, thereby allowing a process step control to be facilitated.

After the detachment and removal treatment (S3 in FIG. 3), a step of recovering a metal may be added. Adding a metal-recovering step allows efficient recovering of a metal material or the like contained in a display member detached and removed from a glass substrate.

Furthermore, a configuration may be used in which after forming the glass fragments (S2 in FIG. 3), the glass fragments 40 that have been formed are sifted through a sieve so as to have a particle size evened out to be in a predetermined particle size distribution. The particle size of the glass fragments 40 is evened out in this manner, and thus in a detachment and removal treatment, an impact force with respect to the front glass substrate 11 or the back glass substrate 21 can be made uniform in a plane direction, thereby allowing an attached member such as a display member to be detached and removed in a uniform manner.

Furthermore, although in this embodiment, the front glass substrate 11 is mounted directly on the conveyor portion 42 as shown in FIG. 5, a support plate may be disposed between the conveyor portion 42 and the front glass substrate 11. Disposing the support plate allows a relative position between the front glass substrate 11 and the conveyor portion 42 to be kept constant, and thus in a detachment and removal treatment, a display member can be detached and removed in a uniform manner. Further, the front glass substrate 11 may be held firmly by vacuum absorption or the like. With the front glass substrate 11 held firmly, a relative position between the front glass substrate 11 and the conveyor portion 42 can be kept constant, and thus in a detachment and removal treatment, a display member can be detached and removed in a uniform manner.

Furthermore, when detaching and removing the back plate display member 28, prior to a detachment and removal treatment by means of the impact of the glass fragment 40, a step of detaching and removing the phosphor layer 25 may be added. The phosphor layer 25 has relatively poor adhesion compared with other layers, and therefore, when an air blowing treatment, a mild blasting treatment or the like is performed with respect to the back plate display member 28 prior to the above-described detachment and removal by means of the impact of the glass fragment 40, a phosphor material alone can be recovered in a sorted state.

Furthermore, although this embodiment describes as an example a configuration including the front plate display member 18 composed of the scanning electrode 12, the sustain electrode 13, the light-blocking layer 15, the dielectric layer 16, and the protective layer 17, and the back plate display member 28 composed of the address electrode 22, the base dielectric layer 23, the partition 24, and the phosphor layer 25, the present invention is not limited thereto and is applicable also to, for example, a configuration further including another film.

### Embodiment 2

[1. Material Recovering Method]

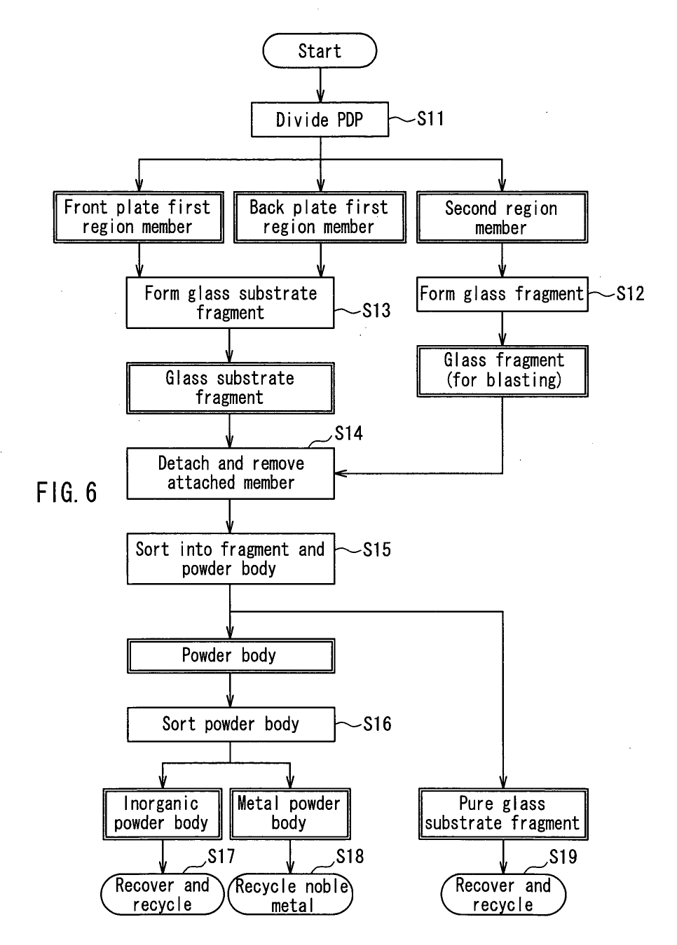

FIG. 6 is a flow chart showing a method of recovering a material of a PDP according to Embodiment 2. In Embodiment 2, the configuration of the PDP 1 and the configuration of the attached member-removing apparatus are the same as those in Embodiment 1, and detailed descriptions thereof thus are omitted. A difference between Embodiment 1 and Embodiment 2 lies in a flow of a material recovering method.

Embodiment 2 describes a material recovering method used suitably with respect to a PDP in which a front glass substrate and a back glass substrate are damaged or broken. That is, in a PDP collected from a user due to the end of its product life or the like, in the process of handling or conveying the PDP, a front glass substrate or a back glass substrate may be damaged or broken. The material recovering method according to Embodiment 2 is a method by which a high quality glass material can be recovered at low cost from a front glass substrate and a back glass substrate that are damaged or broken.

First, the PDP 1 is divided (S11). As described above, in the PDP 1, the front plate 10 and the back plate 20 are attached hermetically to each other at their outer peripheral portions with the sealing portion 27, and therefore, it is necessary for the front plate 10 and the back plate 20 to be separated from each other. In S11, the PDP 1 is cut at predetermined positions so as to be divided into six members that are the front plate first region member 33, the back plate first region member 34, and the second region members 32a, 32b, 32c, and 32d. A specific dividing method is similar to the method performed in S1 shown in FIG. 3, and a detailed description thereof thus is omitted.

Next, the second region members 32a, 32b, 32c, and 32d are pulverized with a pulverizer, and thus glass fragments are formed (S12). A specific forming method is similar to the method performed in the step S2 shown in FIG. 3, and a detailed description thereof thus is omitted.

Meanwhile, the front plate first region member 33 and the back plate first region member 34 that are obtained by a dividing treatment performed in the step S11 are crushed with a crusher or cut with a cutter (in this embodiment, hereinafter, this treatment is referred to as “crushing”), and thus glass substrate fragments are formed (S13). That is, in the case where the front glass substrate 11 and the back glass substrate 12 already have been broken prior to the treatment of dividing the PDP 1 (S11), depending on the degree of the breakage, there may be a case where a blasting treatment cannot be performed with respect to a glass surface. In this embodiment, in the case where, for example, the front glass substrate 11 and the back glass substrate 12 already have been broken prior to the division of the PDP 1, the front plate first region member 33 and the back plate first region member 34 that are obtained by division performed in the step S11 are crushed collectively with the glass substrates and display members so that the glass substrate fragments are formed. The glass substrate fragments have a particle diameter of, for example, about several mm.

Next, the glass fragments formed in the step S12 and the glass substrate fragments formed in the step S13 are allowed to impact mechanically against each other so that the front plate display member 18 and the back plate display member 28 that are attached to the glass substrate fragments are detached and removed (S14). In the step S14, for example, an attached member-removing apparatus as described in Embodiment 1 can be used. That is, the glass fragments (formed in the step S12) are ejected at a high speed by a blasting device of the attached member-removing apparatus toward the glass substrate fragments (formed in the step S13) and thus are allowed to impact against the glass substrate fragments so that the display members attached to the glass substrate fragments are detached and removed.

Next, powder bodies of glass fragments and metal fragments originating in the dielectric layer 16, the base dielectric layer 23, and the like, which are generated in the process of detaching and removing the front plate display member 18 and the back plate display member 28 from the glass substrate fragments in the step S14, and the glass substrate fragments are collected and sorted into fragments and a powder body (S15). As for a powder body obtained by this step of sorting into fragments and a powder body, the glass fragments and the metal fragments that have been collected are sorted into an inorganic powder body and a metal powder body by the specific gravity separation method, the electrostatic separation method, or the like in a powder body-sorting step (S16). The inorganic powder body includes glass fragments originating in the front glass substrate 11 and the back glass substrate 21 and a glass component contained in the dielectric layer 16, the base dielectric layer 23, the partition 24, and the like. Further, the metal powder body is silver, tin, indium, or the like contained mainly in the scanning electrode 12, the sustain electrode 13, the address electrode 22, and the like.

Next, the glass component included in the inorganic powder body obtained by sorting in the step S16 can be recycled as a glass component material by being sorted further into a glass component for a glass substrate, a glass component for a dielectric, and the like (S17).

Furthermore, as for the metal powder body obtained by sorting in the step S16, a noble metal is recovered by the electrolysis technique or the like so that the recovered noble metal can be recycled (S18).

Moreover, as for glass substrate fragments obtained by sorting in the step S15 of sorting into fragments and a powder body, since an attached member has been removed therefrom, the glass substrate fragments are pure glass substrate fragments and thus are recovered in the form of a pure glass substrate and can be recycled by, for example, being remelted (S19).

[2. Effect of Embodiment, etc.]

As described above, according to the material recovering method of Embodiment 2, a material of a PDP in which a front glass substrate and a back glass substrate are broken in a handling process, a conveying process, or the like can be recovered efficiently.

Furthermore, in the step of detaching and removing display members from glass substrate fragments (S14), the display members are detached and removed using glass fragments formed from the second region members 32a, 32b, 32c, and 32d, and thus only a substance constituting the PDP 1 is used, so that the incorporation of any other substance is prevented, thereby facilitating quality maintenance of a material to be recovered.

Furthermore, in the material recovering method according to this embodiment, all the steps are performed using a dry treatment that does not use a solution or the like, and thus a process step control can be facilitated.

It is preferable that the size of glass substrate fragments formed in the step S13 is set arbitrarily depending on the degree of breakage of the front glass substrate 11 and the back glass substrate 21 of the PDP 1.

Furthermore, although in this embodiment, glass substrate fragments are formed based on the front plate first region member 33 and the back plate first region member 34, glass substrate fragments also may be formed based on each of the front plate first region member 33 and the back plate first region member 34. This way of forming glass substrate fragments allows a yield of a glass material to be increased even in the case where adhesion with which the front plate display member 18 is attached to the front plate first region member 33 is of a degree different from the degree of adhesion with which the back plate display member 28 is attached to the back plate first region member 34.

Although the above description has been directed to the case where the front glass substrate 11 and the back glass substrate 21 are damaged or broken, this embodiment is applicable also to the case where the front glass substrate 11 and the back glass substrate 21 are not damaged or broken.

### Embodiment 3

[1. Material Recovering Method]

The description is directed next to a material recovering method according to Embodiment 3 of the present invention. In this embodiment, the configuration of the PDP 1 is similar to the configuration described above in Embodiment 1, and a detailed description thereof thus is omitted.

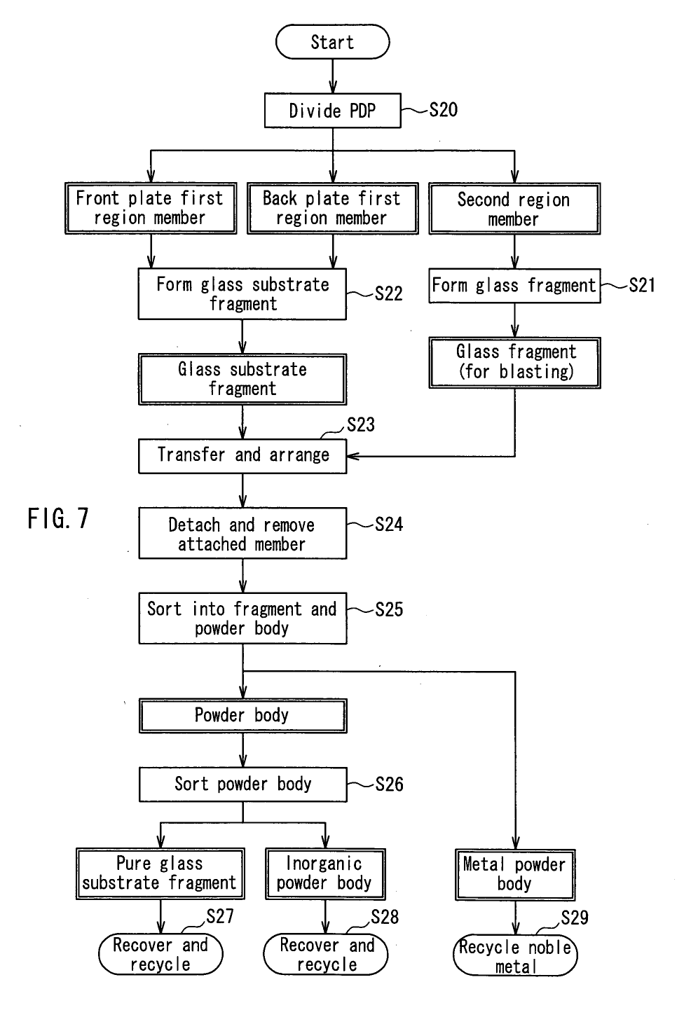

Embodiment 3 relates to a method of recovering a material by detaching and removing attached members including electrodes such as the display electrode 14 and the address electrode 22, the dielectric layer 16, the base dielectric layer 23, the phosphor layer 25, and the like from the front glass substrate 11 and the back glass substrate 21 that are included in a PDP having a defect caused in a manufacturing process, a used PDP that has come to the end of its product life, or the like. This embodiment relates also to a material recovering method used in the case where the front glass substrate 11 and the back glass substrate 21 that are included in the PDP 1 are, for example, not damaged or broken. The following describes a flow of the material recovering method according to this embodiment with reference to FIG. 7.

As shown in FIG. 7, first, the PDP 1 is divided (S20). As described above, in the PDP 1, the front plate 10 and the back plate 20 are attached hermetically to each other at their outer peripheral portions with the sealing portion 27, and therefore, it is necessary that the front plate 10 and the back plate 20 be separated from each other. In the step S20, the PDP 1 is cut at each portion indicated by the alternate long and short dashed line A shown in FIG. 4A so as to be divided into six members that are the front plate first region member 33, the back plate first region member 34, and the second region members 32a, 32b, 32c, and 32d as shown in FIG. 4B. A specific dividing method is similar to the method performed in S11 shown in FIG. 6, and a detailed description thereof thus is omitted.

Next, the second region members 32a, 32b, 32c, and 32d are pulverized with a pulverizer, and thus a glass powder is formed (S21). A specific forming method is similar to the method performed in the step S12 shown in FIG. 6, and a detailed description thereof thus is omitted.

Meanwhile, the front plate first region member 33 and the back plate first region member 34 that are obtained by a dividing treatment performed in the step S20 are crushed with a crusher or cut with a cutter (in this embodiment, hereinafter, this treatment is referred to as “crushing”), and thus glass substrate fragments having a size of several tens of cm are formed (S22). On respective one surfaces of the glass substrate fragments thus obtained, which originate in the first region member 31, the display electrode 14, the dielectric layer 16, the protective layer 17, the base dielectric layer 23, the partition 24, the address electrode 22, and the phosphor layer have been formed to be attached thereto. In this glass substrate-crushing step S22, glass substrates that are not damaged or broken are crushed, thus providing an advantage of allowing a size reduction of a device used in a transferring and arranging step S23 and a device used in an attached member-detachment and removal step S24, which will be described later. A specific method of forming glass substrate fragments is similar to the method performed in the step S13 shown in FIG. 6, and a detailed description thereof thus is omitted.

Next, the glass substrate fragments formed in the glass substrate-crushing step S22 are transferred to and arranged in a predetermined position in an attached member-removing apparatus (S23).

Next, the glass powder formed in the glass powder forming step S21 is ejected and allowed to impact against the glass substrate fragments arranged in the predetermined position. In this manner, attached members such as the display members, which are attached to the glass substrate fragments, are detached and removed (S24).

Next, powder bodies of glass fragments and metal fragments that are generated in the process of detachment and removal in the attached member-detachment and removal step S24 and the glass substrate fragments from which the attached members have been removed are collected and sorted into fragments and a powder body, specifically, into glass fragments and a powder body (an inorganic powder body and a metal powder body) (S25). A specific sorting method is similar to the method performed in the step S15 shown in FIG. 6, and a detailed description thereof thus is omitted.

Next, the glass substrate fragments originating in the front glass substrate 11 or the back glass substrate 21, which are obtained by sorting in the step S25 of sorting into fragments and a powder body, contain only a pure glass component and thus can be recycled easily by being remelted (S27).

Furthermore, the inorganic powder body that is obtained by sorting the powder body in the powder body-sorting step S26 and is a glass component contained in the dielectric layer 16, the base dielectric layer 23, and the like can be recycled to be used for a dielectric or the like (S28).

Furthermore, the metal powder body obtained by sorting in the powder body-sorting step S26 can be recycled by being subjected to electrolysis or the like so that a noble metal is recovered (S29).

[2. Attached Member-Removing Method]

The following describes operations in the steps S23 and S24 in detail.

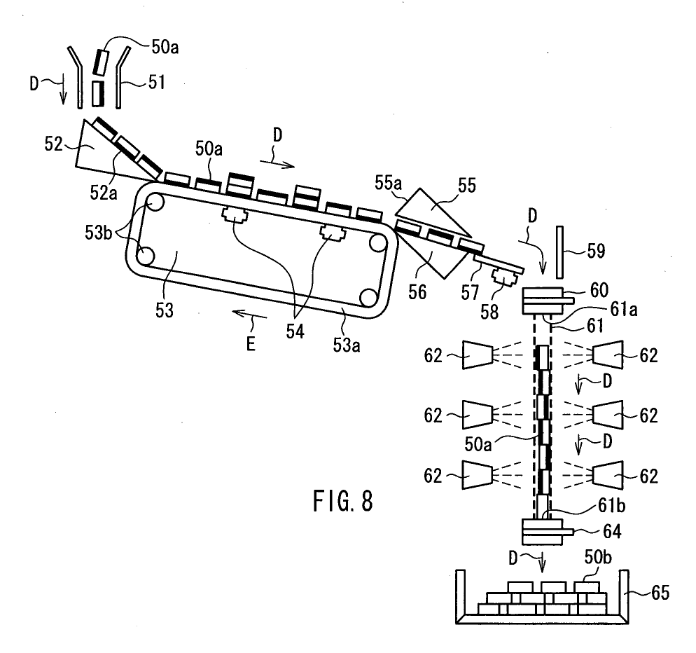

FIG. 8 shows a configuration of an attached member-removing apparatus according to this embodiment. As shown in FIG. 8, the attached member-removing apparatus includes a feeding portion 51, a slanting portion 52, a conveyor portion 53, an electromagnetic oscillator 54, an introducing portion 55, a slanting portion 56, a slanting portion 57, an electromagnetic oscillator 58, a regulating portion 59, a movable valve 60, a housing portion 61, a blasting nozzle 62, openings 61a and 61b, a movable valve 64, and a container 65.

The feeding portion 51 is a portion from which a glass substrate fragment 50a is fed into this apparatus. The glass substrate fragment 50a is a glass substrate fragment formed in S22 shown in FIG. 7.

The slanting portion 52 is disposed downstream of the feeding portion 51. The slanting portion 52 includes a slanting surface 52a that allows the glass substrate fragment 50a to slide to the side of the conveyor portion 53.

The conveyor portion 53 includes a belt 53a on which the glass substrate fragment 50a can be mounted and four driving shafts 53b on which the belt 53a is wound and that are driven to be rotated by driving means such as a motor. It is preferable that the belt 53a is provided with a side wall (not shown) at each end portion thereof in a width direction so that the glass substrate fragment 50a being transferred is prevented from falling off of the belt 53a.

The electromagnetic oscillator 54 is disposed on a rear surface side of a surface of the belt 53a on which the glass substrate fragment 50a is mounted. The electromagnetic oscillator 54 is configured so as to oscillate when energized. The oscillation of the electromagnetic oscillator 54 causes the belt 53a to oscillate.

The introducing portion 55 is disposed downstream of the conveyor portion 53. Further, the introducing portion 55 is disposed opposite to the slanting portion 56 via a predetermined gap. The gap between the introducing portion 55 and the slanting portion 56 has a dimension that is not less than 1.5 times and less than twice the thickness of the glass substrate fragment 50a. Therefore, only one sheet of glass substrate fragment 50a can pass through between the introducing portion 55 and the slanting portion 56. Further, at an end portion of the introducing portion 55 on a side of the conveyor portion 53, a regulating surface 55a for transfer regulation is formed, which prevents a plurality of sheets of glass substrate fragments 50a overlapping one another from being transferred downstream.

The slanting portion 56 is disposed downstream of the introducing portion 55. The slanting portion 56 includes a slanting surface so as to allow the glass substrate fragment 50a that has come out of the conveyor portion 53 to slide to the side of the slanting portion 57 downstream thereof.

The slanting portion 57 is disposed downstream of the slanting portion 56. The slanting portion 57 includes a slanting surface so as to allow the glass substrate fragment 50a that has passed through between the introducing portion 55 and the slanting portion 56 to slide to the side of the housing portion 61 downstream thereof.

The electromagnetic oscillator 58 is disposed at a lower portion of the slanting portion 57. The electromagnetic oscillator 58 is configured so that when energized, it causes the slanting portion 57 to oscillate.

The regulating portion 59 is disposed so that the glass substrate fragment 50a that has passed over the slanting portion 57 is guided to the side of the housing portion 61 and is prevented from falling off a transfer path.

The movable valve 60 is disposed so as to allow an opening at an upper portion of the housing portion 61 to be opened and closed. Further, when a predetermined quantity of the glass substrate fragments 50a are housed in the housing portion 61, the movable valve 60 closes the opening at the upper portion of the housing portion 61 so as to prevent the glass substrate fragments 50a in a quantity larger than the predetermined quantity from being fed into the housing portion 61.

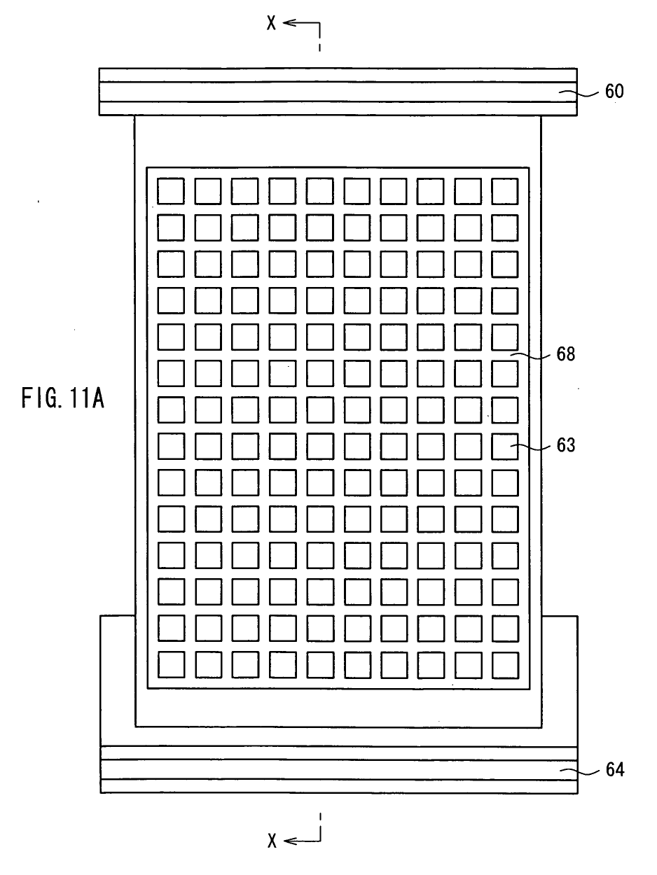

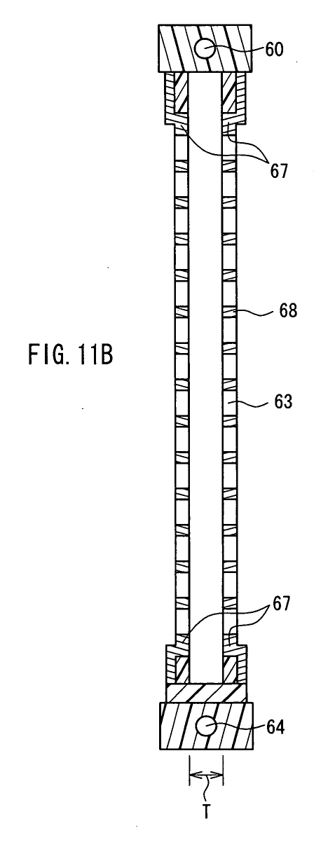

In the housing portion 61 (housing body), a space in which a predetermined quantity of the glass substrate fragments 50a can be housed is provided inside, and openings 61a and 61b are provided at an upper portion and a lower portion thereof, respectively. FIG. 11A is a diagram of the housing portion 61 as seen from a side of the blasting nozzle 62. FIG. 11B shows a cross section taken along line X-X of FIG. 11A. The housing portion 61 has a configuration in which two plate-shaped punching metals 68 (a first plate body, a second plate body) are disposed opposite to each other, on side surfaces of which openings 63 formed of a plurality of through holes are formed. The punching metals 68 are fixed to a holder 67 at each of an upper end and a lower end thereof. Further, a width T between inner surfaces of the punching metals 68 is at least not less than a thickness of one sheet of glass substrate fragment 50a (preferably, not less than a thickness of one and a half sheets of glass substrate fragments 50a) and less than a thickness of two sheets of glass substrate fragments 50a. Therefore, the glass substrate fragment 50a that has been inserted into the housing portion 61 via the opening 61a is allowed to fall freely toward a lower end side of the housing portion 61 (a side of the opening 61b).

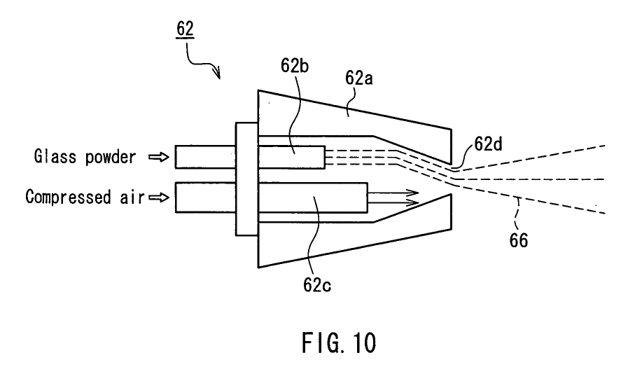

The blasting nozzle 62 is disposed at each of positions opposed to the openings 63 formed in the housing portion 61 so that it can eject a grinding material made of a glass powder or the like toward the housing portion 61. In this embodiment, as the grinding material, a glass powder 66 is used that is obtained by pulverizing the second region members 32 with a pulverizer and has a particle diameter of several tens of μm to several thousands of μm. This glass powder 66, whose main component is glass, satisfies a hardness condition as a grinding material and does not contaminate a glass substrate to be recovered with impurities. Further, the blasting nozzle 62 is disposed at each of positions opposed to side surfaces in the housing portion 61, on which the openings 63 are formed, so that it can inject the grinding material to each of front and rear surfaces of the glass substrate fragment 50a positioned in the housing portion 61. FIG. 10 shows one configuration of the blasting nozzle 62. As shown in FIG. 10, the blasting nozzle 62 includes a first nozzle 62b for ejecting a blasting material (the glass powder 66 is used in this embodiment) into a case 62a and a second nozzle 62c for ejecting compressed air. The glass powder 66 formed using a pulverizer (not shown) is supplied to the first nozzle 62b. The glass powder 66 ejected from the first nozzle 62b can be ejected at a high speed to the exterior via an opening 62d formed in the case 62a by means of the compressed air ejected at a high speed from the second nozzle 62c. Although FIG. 10 shows a configuration of a two-nozzle type including the first nozzle 62b for ejecting a blasting material and the second nozzle 62c for ejecting compressed air, it also is possible to use a configuration of a one-nozzle type in which a blasting material is ejected into compressed air.

The openings 63 are formed on each of the two opposed side surfaces in the housing portion 61. Each of the openings 63 is formed so as to be at least larger than a particle diameter of the glass powder 66 ejected from the blasting nozzle 62 and smaller than the size of the glass substrate fragment 50a. Therefore, the openings 63 are formed in such a size as to allow the passing of the glass powder 66 and not to allow the passing of the glass substrate fragment 50a.

The movable valve 64 is disposed so as to allow the opening 61b at the lower portion of the housing 61 to be opened and closed. When the glass substrate fragment 50a is inserted into the housing portion 61 and when a blasting treatment is being performed with respect to the glass substrate fragment 50a housed in the housing portion 61, the movable valve 64 closes the opening 61b. Further, when the glass substrate fragment 50a is discharged from the housing portion 61, the movable valve 64 opens the opening 61b.

After the front plate display member 18 and the back plate display member 28 have been removed from the glass substrate fragment 50a through the ejection from both sides in the housing portion 61 using the blasting nozzle 62, glass substrate fragments 50b are discharged and can be housed in the container 65.

The following describes an operation. In the following description, the glass substrate fragment 50a is a glass substrate fragment to which a display member is attached, and the glass substrate fragment 50b is a pure glass substrate fragment from which either of the front plate display member 18 and the back plate display member 28 (hereinafter, both are referred to generically as “display members”) has been detached and removed.

When removing an attached member such as a display member, which is attached to the glass substrate fragment 50a, first, the glass substrate fragment 50a is fed into the feeding portion 51. The glass substrate fragment 50a slides over the slanting surface 52a of the slanting portion 52 and is mounted on the belt 53a of the conveyor portion 53. Since the belt 53a is driven in a direction indicated by an arrow E, the glass substrate fragment 50a is transferred in a direction indicated by an arrow D. The electromagnetic oscillator 54 is energized so as to oscillate, so that the oscillation is transmitted to the belt 53a. The belt 53a thus oscillates, and thus in the case where a plurality of sheets of glass substrate fragments 50a mounted on the belt 53a overlap one another, with respect to one of the glass substrates 50a, another one of the glass substrates 50a mounted on the one of the glass substrates 50a can be made to fall onto the belt 53a. This allows a single layer transfer to be performed.

Next, the glass substrate fragment 50a slides though between the introducing portion 55 and the slanting portion 56 and moves onto the slanting portion 57. Herein, since the gap between the introducing portion 55 and the slanting portion 56 has a dimension that is not less than 1.5 times and less than twice the thickness of one sheet of glass substrate fragment 50a, only one sheet of glass substrate fragment 50a can pass through between the introducing portion 55 and the slanting portion 56. In this configuration, if a plurality of sheets of glass substrate fragments 50a overlap one another, with respect to one of the glass substrate fragments 50a, another one of the glass substrate fragments 50a mounted on the one of the glass substrate fragments 50a comes into contact with the regulating surface 55a and falls onto the belt 53a. That is, the regulating surface 55a is disposed so as to transfer the glass substrate fragment 50a in a single layer state. Further, the electromagnetic oscillator 58 disposed at the lower portion of the slanting portion 57 is energized so as to oscillate and thus can cause the slanting portion 57 to oscillate so that the glass substrate fragment 50a positioned on the slanting portion 57 can be transferred smoothly to the side of the housing portion 61.

Next, the glass substrate fragment 50a is inserted into the housing portion 61, while a transfer direction thereof is regulated at the regulating portion 59. At this time, since the movable valve 60 is opened, the glass substrate fragment 50a moves into the housing portion 61 via the opening 61a. The housing portion 61 is provided in such a manner as to stand substantially vertically, so that in the housing portion 61, the glass substrate fragment 50a falls freely in a perpendicular direction. The opening 61b formed at a lower end of the housing portion 61 is closed with the movable valve 64, so that the glass substrate fragment 50a that has fallen in the housing portion 61 comes into contact with and stops at the movable valve 64. In the housing portion 61, a plurality of sheets of glass substrate fragments 50a can be housed in such a manner as to be laminated in the perpendicular direction. Once a predetermined quantity of the glass substrate fragments 50a have been housed in the housing portion 61, the movable valve 60 is closed so as to inhibit further insertion of the glass substrate fragment 50 into the housing portion 61.

Next, a blasting device is operated to eject the glass powder 66 from the blasting nozzles 62. The glass powder 66 ejected from the blasting nozzles 62 impacts against the glass substrate fragment 50a positioned in the housing portion 61 via the openings 63 of the punching metals 68. At this time, the glass powder 66 is being ejected at a high speed from the blasting nozzles 62 and thus impacts against the glass substrate fragment 50a with a high impact force. When the glass powder 66 is allowed to impact against the glass substrate fragment 50a, using an impact force generated thereby, an attached member attached to the glass substrate fragment 50a can be detached and removed. As shown in the figure, the blasting nozzles 62 inject the glass powder from respective sides of the two opposed surfaces of the housing portion 61, and thus it is possible to allow the glass powder to impact against front and rear surfaces of the glass substrate fragment 50a at one time, thereby allowing display members attached to the front and rear surfaces of the glass substrate fragment 50a to be detached and removed. The above-described blasting treatment is performed for a predetermined period of time, and thus the glass substrate fragment 50b from which the display members have been removed can be obtained.

Furthermore, in the blasting treatment, the housing portion 61 is swung in a vertical direction or a horizontal direction by a swinging mechanism (not shown). In the case where the glass substrate fragment 50a is not swung in the blasting treatment, a relative position between the glass substrate fragment 50a and the openings 63 is not varied. Consequently, while it is possible to allow the glass powder 66 to impact against a portion of the glass substrate fragment 50a that is opposed to the openings 63, it is not possible to allow the glass powder 66 to impact against a portion of the glass substrate fragment 50a that is opposed to an area without the openings 63. On the other hand, when the glass substrate fragment 50a is swung in the vertical direction in the blasting treatment as in this embodiment, a relative position between the glass substrate fragment 50a and the openings 63 can be varied, and thus it is possible to allow the glass powder 66 to impact against the glass substrate fragment 50a in a uniform manner. As the swinging mechanism, for example, the electromagnetic oscillators 54 and 58 can be used.

Next, the movable valve 64 is opened so that the glass substrate fragment 50b housed in the housing portion 61 is discharged from the housing portion 61. The discharged glass substrate fragment 50b is housed in the container 65 disposed below the housing portion 61.

Next, when performing the blasting treatment with respect to another one or set of the glass substrate fragments 50a, the movable valve 64 is closed and the movable valve 60 is opened so that the another one or set of the glass substrate fragments 50a is housed in the housing portion 61. A subsequent operation is performed similarly to the above, and a description thereof thus is omitted.

[3. Effect of Embodiment, etc.]

According to this embodiment, it is possible to recover pure glass fragments by detaching and removing an attached member from the glass substrate fragment 50a originating in the front glass substrate 11 or the back glass substrate 21 that constitute a display panel. The recovered pure glass fragments are a pure glass component and thus can be recycled easily by being remelted.

Furthermore, according to this embodiment, since a blasting treatment is performed with respect to both of a front surface and a rear surface of a glass substrate, attached members such as display members, which are attached to both the surfaces of the glass substrate, can be detached and removed at one time, and thus the glass substrate alone can be recovered efficiently. That is, a large number of glass substrates can be recovered in a short time.

Furthermore, this embodiment has a configuration in which a spacing T between the opposed surfaces of the pair of punching metals 68 is not less than a thickness of one sheet of glass substrate fragment 50a (preferably, not less than a thickness of one and a half sheets of glass substrate fragments 50a) and less than twice the thickness, and thus the glass substrate fragments 50a are prevented from overlapping one another in a horizontal direction in the housing portion 61. Thus, in a blasting treatment, an attached member attached to the glass substrate fragment 50a can be detached and removed reliably.

Although in this embodiment, a glass powder formed in S21 is used as a powder for a blasting treatment, a powder for a blasting treatment is not limited thereto. A powder other than the glass powder formed in S21 also may be used as long as it at least allows removal of attached members attached to glass substrate fragments in a blasting treatment. Further, it is preferable that a powder used for a blasting treatment has a high hardness because such a powder allows attached members to be removed more efficiently.

Furthermore, a configuration may be used in which the housing portion 61 is swung when the glass substrate fragment 50a is housed in the housing portion 61. According to this configuration, in the case where the glass substrate fragment 50a is caught in any of the openings 63 while falling freely in the housing portion 61, the housing portion 61 is swung by a swinging mechanism so as to allow the glass substrate fragment 50a to fall to a predetermined position. This configuration also allows a blasting treatment to be performed uniformly even with respect to a portion that is shaded by the punching metals 68 and thus cannot be subjected to the blasting treatment.

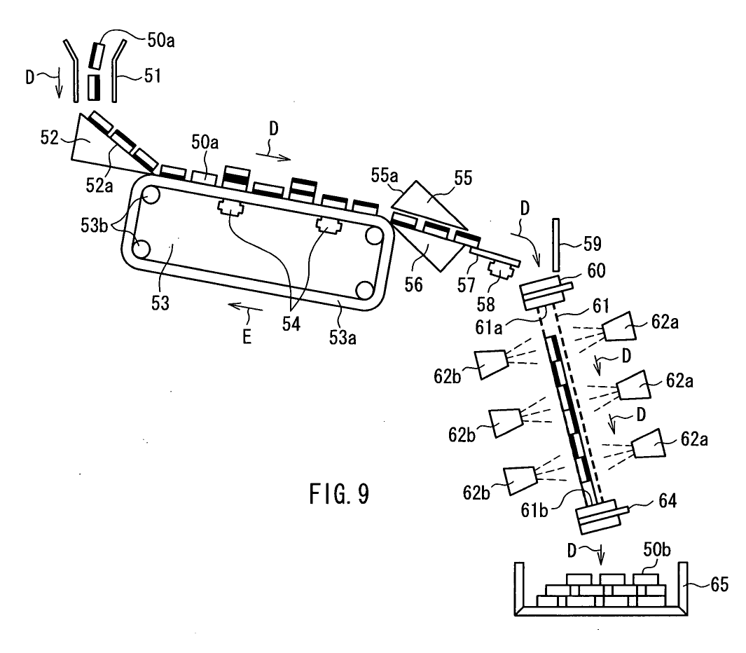

Furthermore, the housing portion 61 is not limited to the configuration shown in FIG. 8 in which the housing portion 61 is provided in such a manner as to stand in a perpendicular direction and also may be configured to be disposed in a slanted manner. FIG. 9 shows a configuration in which the housing portion 61 is disposed in such a manner as to be slanted with respect to the perpendicular direction. With this configuration, when the glass substrate fragment 50a moves to fall in the housing portion 61, it moves while sliding over the inner surfaces of the punching metals 68. Because of this, the glass substrate fragment 50a falls at a lower speed compared with the case of the configuration shown in FIG. 8, and thus it is possible to perform a blasting treatment consecutively by allowing the glass substrate fragment 50a to move to fall in the housing portion 61, with the movable valves 60 and 64 kept in an opened state.

In the configuration shown in FIG. 9, when the glass substrate fragment 50a moves to fall in the housing portion 61, there is a possibility of a corner portion of the glass substrate fragment 50a being caught in one of the openings 63 formed on the punching metals 68. In that case, the glass substrate fragment 50a is stopped in the middle of a falling path in the housing portion 61, so that a consecutive blasting treatment cannot be performed. In this embodiment, an injection pressure of a blasting nozzle 62b for injecting a grinding material from obliquely downward to the housing portion 61 is set to be higher than an injection pressure of a blasting nozzle 62a for injecting a grinding material from obliquely upward to the housing portion 61. Thus, the glass substrate fragment 50a falls while slightly floating obliquely upward due to the injection pressure of the blasting nozzle 62b, and thus it is possible to prevent the corner portion of the glass substrate fragment 50a from being caught in any of the openings 63. This prevents the glass substrate fragment 50a from being stopped in the middle of a falling path in the housing portion 61, thereby allowing a consecutive blasting treatment to be performed.

Although the above description has been directed to the case where the front glass substrate 11 and the back glass substrate 21 are not damaged or broken, this embodiment is applicable also to the case where the front glass substrate 11 and the back glass substrate 21 are broken.

### Embodiment 4

[1. Material Recovering Method]

The description is directed next to a material recovering method according to Embodiment 4 of the present invention. In this embodiment, the configuration of a PDP is similar to the configuration described above in Embodiment 1, and a detailed description thereof thus is omitted. This embodiment is different from Embodiment 3 described above merely in steps of a glass recovering method.

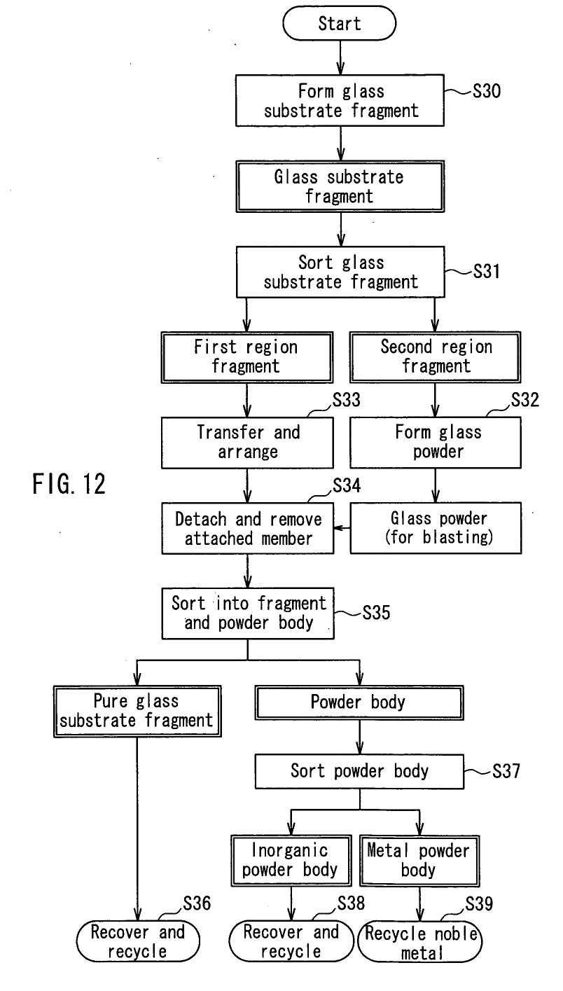

Embodiment 4 relates to a method of recovering a material by detaching and removing attached members including electrodes such as the display electrode 14 and the address electrode 22, the dielectric layer 16, the base dielectric layer 22, the phosphor layer 25, and the like from the front plate 10 and the back plate 20 that are included in a PDP having a defect caused in a manufacturing process, a used PDP that has come to the end of its product life, or the like. This embodiment relates also to a material recovering method used in the case where the front glass substrate 11 and the back glass substrate 21 that are included in a PDP are, for example, damaged or broken. In the case of a PDP in which the front glass substrate 11 and the back glass substrate 21 are damaged or broken, it is difficult to identify a position of the sealing portion 27, thus requiring that glass fragments including the sealing portion 27 be removed selectively. The following describes a flow of the material recovering method according to this embodiment with reference to FIG. 12.

As shown in FIG. 12, first, a glass substrate of the PDP 1 is crushed or cut (in this embodiment, hereinafter, this treatment is referred to generically as “crushing”), and thus glass fragments are formed (S30). Specifically, the glass substrate constituting a display panel is crushed with a crusher into pieces having a size of about several cm to several tens of cm. The display electrode 14, the dielectric layer 16, and the protective layer 17 have been attached to respective one surfaces of glass substrate fragments originating in the front plate first region member 33 shown in FIG. 4C. Further, the address electrode 22, the base dielectric layer 23, the partition 24, and the phosphor layer 25 have been attached to respective one surfaces of glass substrate fragments originating in the back plate first region member 34. Further, glass fragments originating in the second region members 32a, 32b, 32c, and 32d mainly are based on the front glass substrate 11 and the back glass substrate 21 that are adhered to each other with the sealing portion 27. Further, the second region members 32a, 32b, 32c, and 32d have a thickness not less than twice the thickness of a glass substrate fragment originating in the first region member 31.

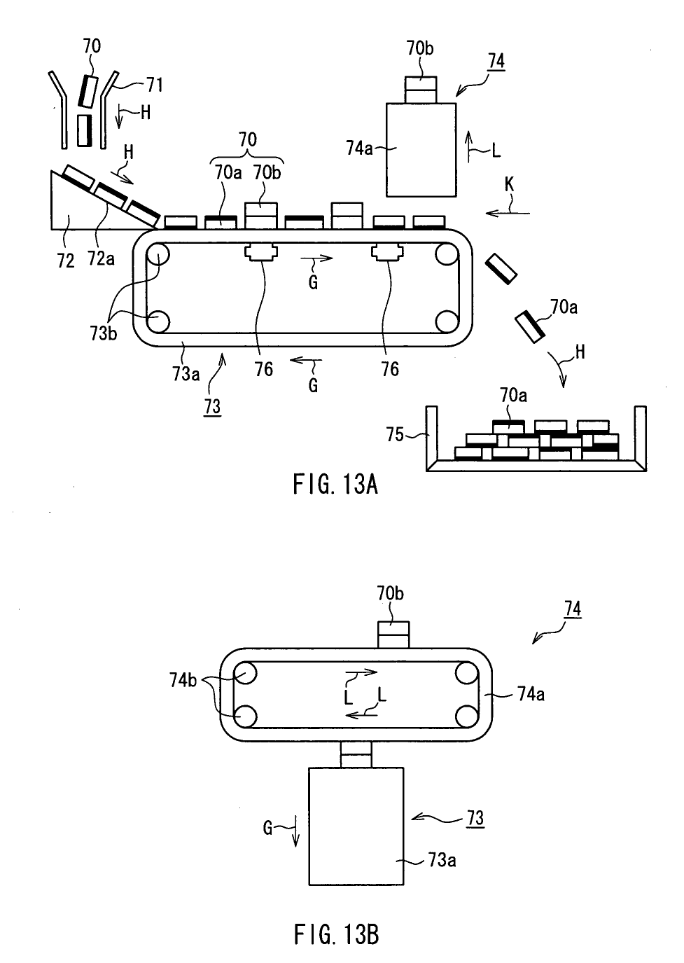

Next, the glass substrate fragments formed in the step S30 are sorted (S31). Specifically, using a fragment-sorting apparatus shown in FIG. 13, based on the thickness of the glass substrate fragments, the glass substrate fragments are sorted into a first region fragment 70a that is a glass substrate fragment originating in the first region member 31 and a second region fragment 70b that is a glass substrate fragment originating in the second region members 32a, 32b, 32c, and 32d. The details of a configuration and operation of the fragment-sorting apparatus will be described later.

Next, the second region fragments 70b are pulverized with a pulverizer, and thus a glass powder is formed (S32).

Next, the first region fragments 70a are transferred to and arranged in a predetermined position in an attached member-removing apparatus (S33).

Next, the glass powder formed in the step S32 is ejected to and allowed to impact against the first region fragments 70a arranged in the predetermined position so that attached members such as display members attached to the first region fragments 70a are removed (S34).

Next, the glass substrate fragments from which the attached members have been detached and removed in the step S34, and glass fragments and metal fragments that are generated in the process of detachment and removal are collected and sorted into fragments and a powder body, specifically, into glass substrate fragments and a powder body (an inorganic powder body and a metal powder body) (S35). The specific sorting method is similar to the method preformed in the step S15 shown in FIG. 6, and a detailed description thereof thus is omitted.

Next, the glass substrate fragments originating in the front glass substrate 11 or the back glass substrate 21, which are obtained by sorting in the step S35, are a pure glass component and thus can be recycled easily by being remelted (S36).

Furthermore, the powder body obtained by sorting in the step S35 is sorted into the inorganic powder body that is a glass component contained in the dielectric layer 16, the base dielectric layer 23, and the like and the metal powder body contained in the display electrode 14, the address electrode 22, and the like (S37).

This inorganic powder body can be recycled to be used for a dielectric or the like (S38), and the metal powder body can be recycled by being subjected to the electrolysis technique or the like so that a noble metal is recovered (S39).

[2. Method of Sorting Glass Substrate Fragments]

The following describes a method of sorting glass substrate fragments performed in the step S31 in detail.

FIGS. 13A and 13B show a configuration of the fragment-sorting apparatus according to this embodiment. FIG. 13B is a diagram of the fragment-sorting apparatus shown in FIG. 13A as seen from a direction indicated by an arrow K. As shown in FIGS. 13A and 13B, the fragment-sorting apparatus includes a feeding portion 71, a slanting portion 72, a first conveyor portion 73, a second conveyor portion 74, a container 75, and an electromagnetic oscillator 76.

The feeding portion 71 is a portion from which a glass substrate fragment 70 is fed into this apparatus. The glass substrate fragment 70 is a glass substrate fragment formed in S31 shown in FIG. 12.

The slanting portion 52 is disposed downstream of the feeding portion 71 and includes a slanting surface 72a that allows the glass substrate fragment 70 to be transferred to the side of the first conveyor portion 73.

The first conveyor portion 73 includes a belt 73a on which the glass substrate fragment 70 can be mounted and four driving shafts 73b on which the belt 73a is wound and that are driven to be rotated by driving means such as a motor. It is preferable that the belt 73a is provided with a side wall (not shown) at each end portion thereof in a width direction so that the glass substrate fragment 70 being transferred is prevented from falling off of the belt 73a.

The second conveyor portion 74 includes a belt 74a with a surface to which an adhesive is applied and four driving shafts 74b on which the belt 74a is wound and that are driven to be rotated by driving means such as a motor. Further, the second conveyor portion 74 is disposed above the first conveyor portion 73 in such a manner that its longitudinal direction is substantially orthogonal to a longitudinal direction of the first conveyor portion 73. Further, a gap between the first conveyor portion 73 and the second conveyor portion 74 is set to have a dimension that is not less than 1.5 times the thickness of the first region fragment 70a (one sheet of glass substrate fragment) and is less than a thickness of the second region fragment 70b (two sheets of glass substrate fragments). Thus, when the first region fragment 70a and the second region fragment 70b are transferred in the first conveyor portion 73, respectively, the first region fragment 70a passes therethrough without coming into contact with the second conveyor portion 74, whereas the second region fragment 70b comes into contact with the second conveyor portion 74.

The container 75 is used to house the first region fragment 70a alone obtained by sorting in the first conveyor portion 73 and the second conveyor portion 74.

The electromagnetic oscillator 76 is disposed on a rear surface side of a surface of the belt 73a on which the glass substrate fragment 70 is mounted, and is configured so that when energized, it causes the belt 73a to oscillate.

The following describes an operation.

When sorting the glass substrate fragments 70 into the first region fragment 70a and the second region fragment 70b, first, the glass substrate fragment 70 is fed into the feeding portion 71. The glass substrate fragment 70 slides over the slanting surface 72a of the slanting portion 72 and is mounted on the belt 73a of the first conveyor portion 73. The belt 73a is driven toward a direction indicated by an arrow G, so that the glass substrate fragment 70 is transferred toward a direction indicated by an arrow H. The electromagnetic oscillator 76 is energized so as to oscillate, so that the oscillation is transmitted to the belt 73a. The belt 73a thus is caused to oscillate, and thus the glass substrate fragments 70 in a state where a plurality of sheets of them overlap one another can be shifted to a state where they are placed one by one in a single layer.

The glass substrate fragments 70 include the first region fragment 70a and the second region fragment 70b in a mixed state. The first region fragment 70a has a thickness corresponding to one sheet of glass substrate, whereas the second region fragment 70b has a thickness corresponding to two sheets of glass substrates because it is obtained by crushing the front glass substrate 11 and the back glass substrate 21 in a state of being connected by the sealing portion 27. When the above-described glass substrate fragments 70 are transferred in the first conveyor portion 73, the first region fragment 70a is housed in the container 75 without coming into contact with the second conveyor portion 74, whereas the second region fragment 70b comes into contact with the second conveyor portion 74. Since the adhesive is applied to the belt 74a of the second conveyor portion 74, the second region fragment 70b that has come into contact with the belt 74a adheres to the belt 74a. As shown in FIG. 13B, the belt 74a is driven in a direction indicated by an arrow L, so that the second region fragment 70b adhering to the belt 74a is isolated from the first conveyor portion 73.

The second region fragment 70b extracted in the second conveyor portion 74 is recovered separately in this manner, and thus the glass substrate fragments 70 can be sorted into the first region fragment 70a and the second region fragment 70b.

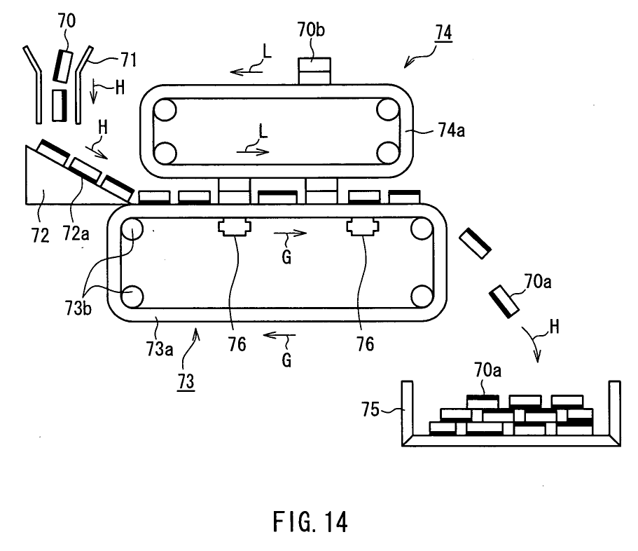

Although in this embodiment, the first conveyor portion 73 and the second conveyor portion 74 are disposed in such a manner that the belt 73a and the belt 74a are substantially orthogonal to each other, the first conveyor portion 73 and the second conveyor portion 74 also may be disposed in such a manner that the belt 73a and the belt 74a are substantially parallel to each other as shown in FIG. 14.

In FIG. 14, constituent elements similar to the constituent elements shown in FIG. 13 are denoted by the same numbers, and detailed descriptions thereof are omitted. When the first conveyor portion 73 and the second conveyor portion 74 are disposed parallel to each other as shown in FIG. 14, the belt 73a and the belt 74a overlap each other in an increased area on a projection surface, and thus the second region fragment 70b can be extracted reliably in the second conveyor portion 74.

[3. Effect of Embodiment, etc.]

As described above, according to this embodiment, in the case where the front glass substrate 11 and the back glass substrate 21 that are included in the PDP 1 are, for example, damaged or broken, prior to an attached member-removing treatment, the glass substrate fragments 70 are sorted into the first region fragment 70a and the second region fragment 70b, and thus a pure glass fragment (first region fragment 70a) from which the attached members have been removed can be recovered efficiently.

Although this embodiment uses a configuration in which the second region fragment 70b is extracted using the belt 74a to which an adhesive is applied, any other configuration also may be used as long as it at least allows the second region fragment 70b to be extracted from among the glass substrate fragments 70 being transferred in the first conveyor portion 73. For example, a configuration is possible in which the second region fragment 70b alone is vacuum-absorbed.

### Embodiment 5

[1. Material Recovering Method]

The description is directed next to a material recovering method according to Embodiment 5 of the present invention. In this embodiment, the configuration of the PDP 1 is similar to the configuration described above in Embodiment 1, and a detailed description thereof thus is omitted.

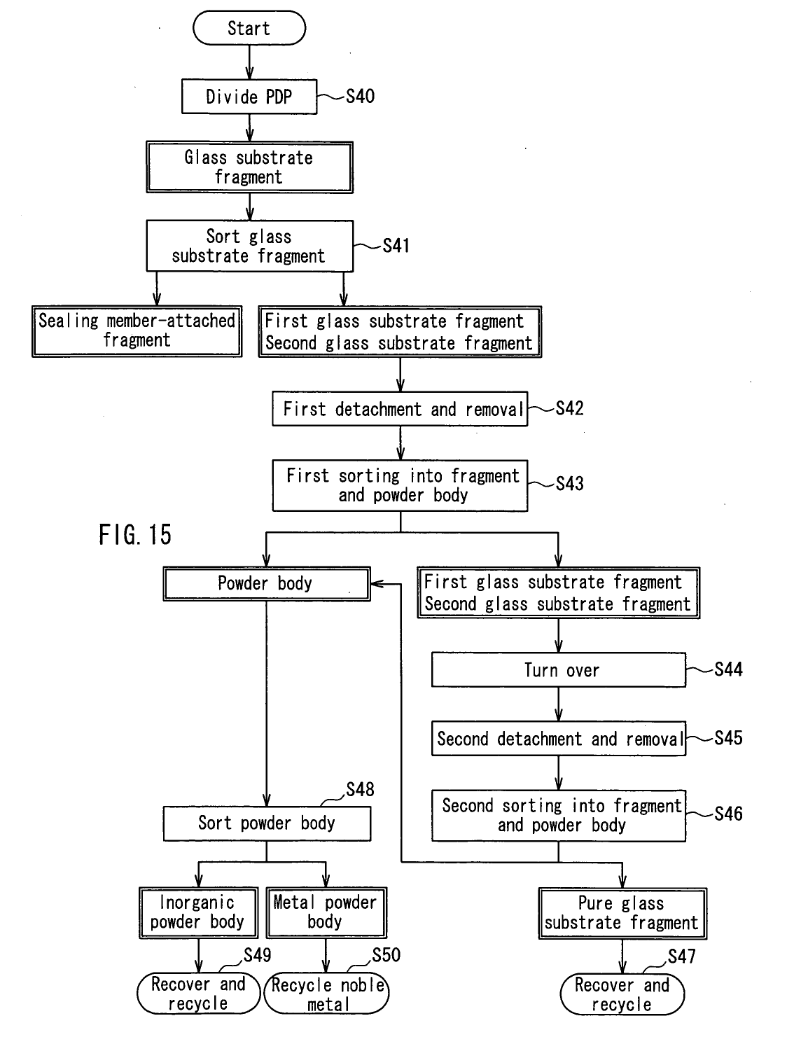

Embodiment 5 relates to a method of recovering a material by detaching and removing attached members including electrodes such as the display electrode 14 and the address electrode 22, the dielectric layer 16, the base dielectric layer 22, the phosphor layer 25, and the like from the front glass substrate 11 and the back glass substrate 21 that are included in a PDP having a defect caused in a manufacturing process, a used PDP that has come to the end of its product life, or the like. This embodiment relates also to a material recovering method used in the case where the front glass substrate 11 and the back glass substrate 21 that are included in a PDP are, for example, damaged or broken. The following describes a flow of the material recovering method according to this embodiment with reference to FIG. 15.

As shown in FIG. 15, first, the front glass substrate 11 and the back glass substrate 21 of the PDP 1 are crushed, and thus glass substrate fragments are formed (S40). Specifically, the front glass substrate 11 and the back glass substrate 21 are crushed with a crusher or cut with a cutter (in this embodiment, hereinafter, these treatments are both referred to generically as “crushing”) into pieces having a size of about several cm to several tens of cm. The display electrode 14, the dielectric layer 16, and the protective layer 17 have been attached to respective one surfaces of glass substrate fragments originating in the front plate first region member 33 shown in FIG. 4C. Further, the address electrode 22, the base dielectric layer 23, the partition 24, and the phosphor layer 25 have been attached to respective one surfaces of glass substrate fragments originating in the back plate first region member 34. Further, glass fragments originating in the second region members 32a, 32b, 32c, and 32d mainly are based on the front glass substrate 11 and the back glass substrate 21 that are adhered to each other with the sealing portion 27. Therefore, when divided, the PDP 1 is segmented into a glass substrate fragment (sealing member-attached fragment) originating in the front glass substrate 11 and the back glass substrate 21 that are adhered to each other at the sealing portion 27, a first glass substrate fragment formed of a glass substrate fragment originating in the front glass substrate 11, and a second glass substrate fragment formed of a glass substrate fragment originating in the back glass substrate 21. In the step S40, it also is possible to divide the PDP 1 at an inner side relative to the sealing portion 27 along the sealing portion 27, and further divide, a region inside the sealing portion 27 obtained by eliminating a region outside the sealing portion 27, into pieces of an appropriate size. Further, although the sealing member-attached fragment has a thickness not less than twice the thickness of each of the front glass substrate 11 and the back glass substrate 21 as a single body, in the case where the region outside the sealing portion 27 is eliminated, glass substrate fragments obtained as the sealing member-attached fragment are substantially evened out in thickness.

Next, the glass fragments formed in the step S40 are sorted (S41). Specifically, the glass fragments are sorted into the sealing member-attached fragment, the first glass substrate fragment, and the second glass substrate fragment. As a sorting method, for example, using the fragment-sorting apparatus described in Embodiment 4 and shown in FIGS. 13A and 13B, sorting can be performed based on the thickness of the glass substrate fragments.

Next, a first detachment and removal is performed in which attached members including an electrode, a dielectric layer, a phosphor layer, and the like are detached and removed from the front glass substrate 11 contained in the first glass substrate fragments and from the back glass substrate 21 contained in the second glass substrate fragments (S42).

Next, glass fragments and metal fragments that are generated in the process of detachment and removal performed in the first detachment and removal step S42 are collected and subjected to a first sorting treatment in which they are sorted into glass substrate fragments and a powder body (an inorganic powder body and a metal powder body) (S43). The glass substrate fragments (the first glass substrate fragment and the second glass substrate fragment) obtained by sorting in the first sorting step S43 are turned over (S44), and then a second detachment and removal is performed in which an attached member attached to the first glass substrate fragment or the second glass substrate fragment is detached and removed (S45), followed by a second sorting step of sorting into glass substrate fragments and a powder body (S46). The first detachment and removal step, the turning-over step, and the second detachment and removal step will be described later. The specific sorting method performed in the first sorting step S42 and the second sorting step S46 is similar to the method performed in S15 shown in FIG. 6, and a detailed description thereof thus is omitted.

Next, the glass fragments obtained by sorting in the step S46, which originate in the front glass substrate 11 or the back glass substrate 21, are a pure glass component and thus can be recycled easily by being remelted (S47).

Furthermore, in a powder body-sorting step (S48), a powder component obtained by sorting in the second sorting step S46 is sorted into an inorganic powder body that is a glass component contained in the dielectric layer 16, the base dielectric layer 23, and the like and a metal powder body contained in the display electrode 14, the address electrode 22, and the like. The inorganic powder body obtained by sorting in the powder body-sorting step S48 can be recycled to be used for a dielectric or the like (S49). Further, the metal powder body obtained by sorting in the powder body-sorting step S48 can be recycled by being subjected to the electrolysis technique or the like so that a noble metal is recovered (S50).

[2. Attached Member-Removing Method]

The following describes operations in the steps S41, S42, S44, and S46 in detail.

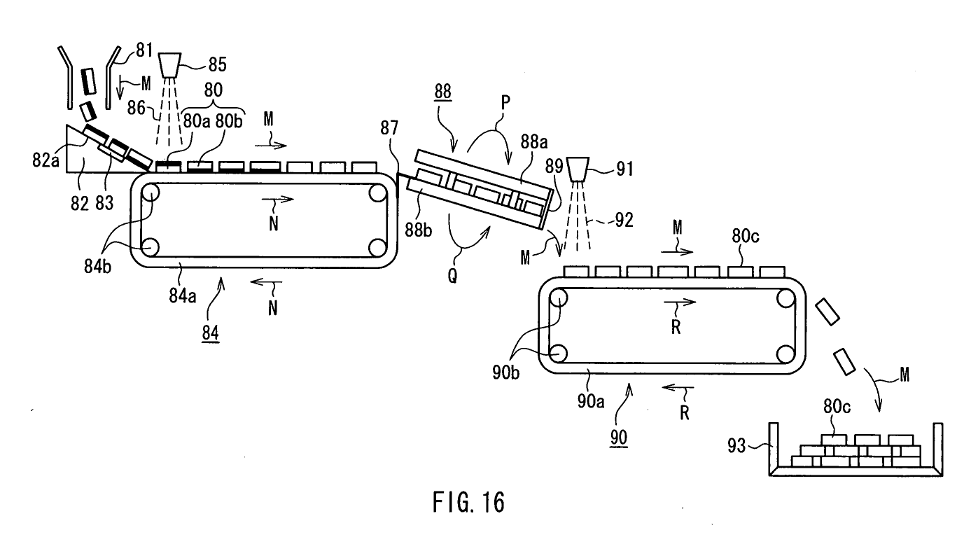

FIG. 16 shows a configuration of an attached member-removing apparatus according to this embodiment. As shown in FIG. 16, the attached member-removing apparatus includes a feeding portion 81, a slanting portion 82, an electromagnetic oscillator 83, a first conveyor portion 84, a first blasting nozzle 85, a first stopper 87, a turning-over mechanism 88, a second stopper 89, a second conveyor portion 90, a second blasting nozzle 91, and a container 93.

The feeding portion 81 is a portion from which a glass substrate fragment 80 is fed into this apparatus. The glass substrate fragments 80 include a first glass substrate fragment 80a and a second glass substrate fragment 80b that are formed in the step S41 shown in FIG. 15 and do not include the sealing member-attached fragments.

The slanting portion 82 is disposed downstream of the feeding portion 81 and includes a slanting surface 82a that allows the glass substrate fragment 80 to be transferred to the side of the first conveyor portion 84.

The electromagnetic oscillator 83 is disposed in such a manner as to be embedded in the slanting portion 82 and is configured so that when energized, it causes the slanting portion 82 to oscillate. The slanting portion 82 is caused to oscillate, and thus the glass substrate fragments 80 in a state where a plurality of sheets of them overlap one another can be shifted to a state where they are placed one by one in a single layer.

The first conveyor portion 84 is disposed downstream of the slanting portion 82 and includes a belt 84a on which the glass substrate fragment 80 can be mounted and four driving shafts 84b on which the belt 84a is wound and that are driven to be rotated by driving means such as a motor. It is preferable that the belt 84a is provided with a side wall (not shown) at each end portion thereof in a width direction so that the glass substrate fragment 80 being transferred is prevented from falling out from the belt 84a.

The first blasting nozzle 85 is disposed above the first conveyor portion 84. Further, the first blasting nozzle 85 is disposed so that it can eject a grinding material 86 made of a glass powder or the like toward the glass substrate fragment 80 mounted on the belt 84a. In this embodiment, as the grinding material, a glass powder, an oxide, and the like that are obtained by powdering the sealing member-attached fragment is used.

The first stopper 87 is disposed downstream of the first conveyor portion 84 and can regulate a transfer of the glass substrate fragment 80 from the first conveyor portion 84 to the turning-over mechanism 88. Specifically, the first stopper 87 is configured so that in the case where the glass substrate fragment 80 is transferred from the first conveyor portion 84 to the turning-over mechanism 88, a transfer path of the glass substrate fragment 80 is opened, and once a predetermined quantity of the glass substrate fragments 80 have been transferred to the turning-over mechanism 88, the transfer path of the glass substrate fragment 80 is closed.

The turning-over mechanism 88 is disposed downstream of the first stopper 87 in such a manner as to be rotatable in a direction indicated by an arrow P. Specifically, the turning-over mechanism 88 includes a spindle that is provided at substantially a center thereof and a first plate body 88a and a second plate body 88b that sandwich the spindle between them. The first plate body 88a and the second plate body 88b are disposed in such a manner that respective principal planes thereof are substantially parallel to each other, and a gap is provided between them, which allows at least one sheet of glass substrate fragment 80 to be present therein (for example, the gap has a size corresponding to the thickness of one and a half sheets of glass substrates). Further, by driving means that is provided separately, the first plate body 88a and the second plate body 88b can be moved in directions in which they move closer to each other and in directions in which they move away from each other. When the glass substrate fragment 80 is inserted into the turning-over mechanism 88, the first plate body 88a and the second plate body 88b are moved in the directions in which they move away from each other, and when the turning-over mechanism 88 is driven to rotate in a state where the glass substrate fragment 80 is inserted therein, the first plate body 88a and the second plate body 88b are moved in the directions in which they move closer to each other so as to hold the glass substrate fragment 80 by sandwiching it therebetween. Further, it is assumed that when, as shown in FIG. 16, the turning-over mechanism 88 is slanted in such a manner as to be at a higher level on a side of the first conveyor portion 84 and at a lower level on a side of the second conveyor portion 90, the turning-over mechanism 88 is in a standard state. In the case where the turning-over mechanism 88 is in the standard state, when the second stopper 89 closes an opening on the side of the second conveyor portion 90 of the turning-over mechanism 88, the glass substrate fragment 80 transferred from the first conveyor portion 84 can be slid to be inserted into the turning-over mechanism 88. Further, in the case where the turning-over mechanism 88 is in the standard state, when the second stopper 89 opens the opening on the side of the second conveyor portion 90 of the turning-over mechanism 88, since the turning-over mechanism 88 is slanted, the glass substrate fragment 80 in the turning-over mechanism 88 can be slid to be transferred to the side of the second conveyor portion 90.

The second stopper 89 is disposed at an end portion of the turning-over mechanism 89 on the side of the second conveyor portion 90 so as to allow the opening of the turning-over mechanism 89 on the side of the second conveyor portion 90 to be opened and closed.

The second conveyor portion 90 is disposed downstream of the turning-over mechanism 88 and includes a belt 90a on which the glass substrate fragment 80 can be mounted and four driving shafts 90b on which the belt 90a is wound and that are driven to be rotated by driving means such as a motor. It is preferable that the belt 90a is provided with a side wall (not shown) at each end portion thereof in a width direction so that the glass substrate fragment 80 being transferred is prevented from falling out from the belt 90a. Further, in a perpendicular direction, the second conveyor portion 90 is disposed in a lower position relative to the first conveyor portion 84. This allows the glass substrate fragment 80 positioned in the turning-over mechanism 88 to be slid over the first plate body 88a or the second plate body 88b that is slanted and thus to be transferred easily to the second conveyor portion 90.

The second blasting nozzle 91 is disposed above the second conveyor portion 90. Further, the second blasting nozzle 91 is disposed so that it can eject a grinding material 92 made of a glass powder or the like toward the glass substrate fragment 80 mounted on the belt 90a. In this embodiment, as the grinding material, a glass powder, an oxide, and the like that are obtained by powdering the sealing member-attached fragment is used.

The container 93 can house the glass substrate fragment 80 discharged from the second conveyor portion 90.

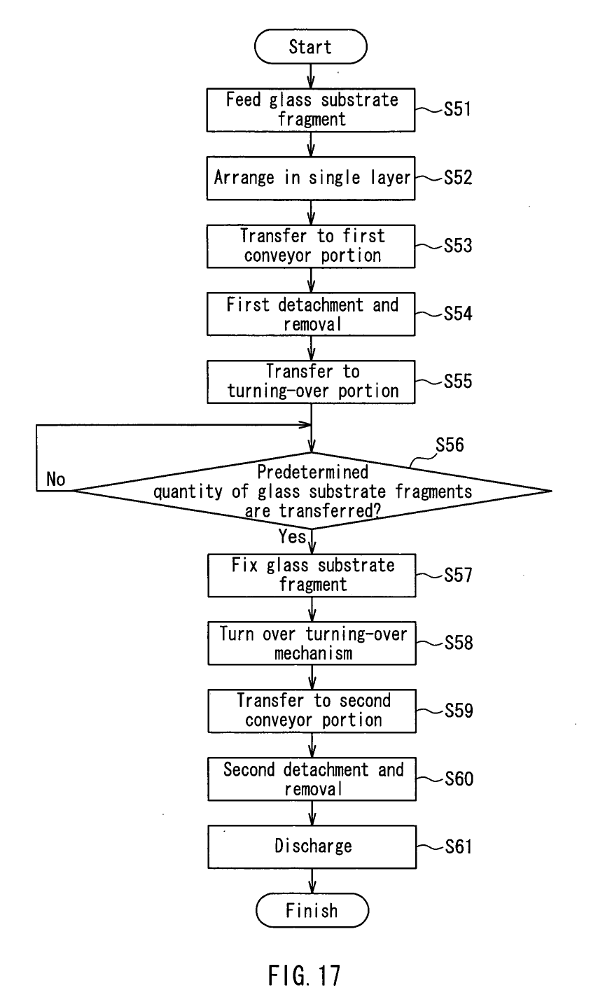

The following describes an attached member-removing operation with reference to FIGS. 16 and 17.

When removing an attached member such as a display member, which is attached to the glass substrate fragment 80, first, the glass substrate fragment 80 is fed into the feeding portion 81 as indicated by an arrow M (S51). The glass substrate fragment 80 falls along the slanting surface 82a of the slanting portion 82 and is mounted on the belt 84a of the first conveyor portion 84. At this time, the slanting portion 82 is swung by the electromagnetic oscillator 83, and thus the glass substrate fragments 80 in a state where a plurality of sheets of them overlap one another can be shifted to a state where they are placed in tandem one by one (S52).

Since the belt 84a is driven in a direction shown by an arrow N, the glass substrate fragment 80 is transferred in a direction indicated by an arrow M (S53). Herein, surfaces of the glass substrate fragments 80 transferred to the first conveyor portion 84, to which attached members are attached, are not necessarily facing the same direction. For example, in the example shown in FIG. 16, a surface of the glass substrate fragment 80a, to which an attached member is attached, is facing upward (to the side of the first blasting nozzle 85), whereas a surface of the glass substrate fragment 80b, to which an attached member is attached, is facing downward (to the side of the belt 84a). In FIG. 16, an attached member attached to the glass substrate fragment 80 is depicted by a bold line.

Next, a blasting device is operated to eject the grinding material 86 from the first blasting nozzle 85 (S54). The grinding material 86 ejected from the first blasting nozzle 85 impacts against the glass substrate fragment 80 positioned on the belt 84a. At this time, the grinding material 86 is being ejected at a high speed from the first blasting nozzle 85 and thus is allowed to impact against the glass substrate fragment 80 with a high impact force. When the grinding material 86 is allowed to impact against the glass substrate fragment 80, using an impact force generated thereby, an attached member attached to the glass substrate fragment 80 can be detached and removed. The first blasting nozzle 85 is capable of allowing the grinding material 86 to impact against only one principal plane of the glass substrate fragment 80 positioned on the belt 84a, so that detachment and removal of an attached member can be performed only with respect to the glass substrate fragment 80a whose attached member-attached surface is facing upward.

Next, the glass substrate fragment 80 transferred by the first conveyor portion 84 is inserted into the turning-over mechanism 88 (S55). At this time, the first stopper 87 is opened, and the second stopper 89 is closed. Further, since the turning-over mechanism 88 is in a slanted state as shown in FIG. 16, the glass substrate fragment 80 falls along the first plate body 88a or the second plate body 88b and come into contact with the second stopper 89 in a closed state. The gap between the first plate body 88a and the second plate body 88b has a size not less than 1.5 times and lower than twice the thickness of one sheet of glass substrate fragment 80, which allows the glass substrate fragment 80 to slide smoothly and prevents overlapping of a plurality of sheets of glass substrate fragments 80 in the turning-over mechanism 88.

Next, when a predetermined quantity of the glass substrate fragments 80 are inserted into the turning-over mechanism 88, the first stopper 87 closes a transfer path of the glass substrate fragment 80 so that another one or set of the glass substrate fragments 80, which is discharged from the first conveyor portion 84, is inhibited from being transferred to the side of the turning-over mechanism 88 (S56). At this time, the operation of the blasting device is halted so as to halt the ejection of the grinding material 86 from the first blasting nozzle 85.

Next, the turning-over mechanism 88 moves the first plate body 88a and the second plate body 88b in the directions in which they move closer to each other. The first plate body 88a and the second plate body 88b hold the glass substrate fragment 80 by sandwiching it therebetween (S57).

Next, the turning-over mechanism 88 is driven to be rotated 180 degrees in the direction indicated by the arrow P from the state shown in FIG. 16 by a driving mechanism that is provided separately (S58). This brings about a state where the first plate body 88a and the second plate body 88b are reversed in their positions, resulting in a state where the glass substrate fragment 80 in the turning-over mechanism 88 is turned over. The turning-over mechanism 88 is in a slanted state even after being turned over, so that the glass substrate fragment 80 slides to the side of the second conveyor portion 90. The glass substrate fragment 80 discharged from the turning-over mechanism 88 is mounted on the belt 90a of the second conveyor portion 90 (S59). In a state where the glass substrate fragment 80 is mounted on the belt 90a, a surface of the glass substrate fragment 80, which had faced upward when the glass substrate fragment 80 had been mounted on the belt 84a, has now turned to be a lower surface. Once the glass substrate fragments 80 that had been present in the turning-over mechanism 88 have all been discharged, the turning-over mechanism 88 is rotated 180 degrees in a direction indicated by an arrow Q and shifted to the standard state shown in FIG. 16.

Next, the glass substrate fragment 80 is transferred in a direction indicated by the arrow M by the belt 90a being driven toward a direction indicated by an arrow R. At this time, the blasting device is operated to eject the grinding material 92 from the second blasting nozzle 91 (S60). The grinding material 92 ejected from the second blasting nozzle 91 impacts against the glass substrate fragment 80 positioned on the belt 90a. At this time, the grinding material 92 is being ejected at a high speed from the second blasting nozzle 91 and thus impacts against the glass substrate fragment 80 with a high impact force. When the grinding material 92 is allowed to impact against the glass substrate fragment 80, using an impact force generated thereby, an attached member attached to the glass substrate fragment 80 can be detached and removed. The second blasting nozzle 91 is capable of allowing the grinding material 92 to impact against only one principal plane of the glass substrate fragment 80 positioned on the belt 90a, so that detachment and removal of an attached member can be preformed only with respect to the glass substrate fragment 80b whose attached member-attached surface is facing upward. The glass substrate fragment 80 from which an attached member has been detached and removed using the first blasting nozzle 85 or the second blasting nozzle 91 is referred to as a “glass substrate fragment 80c”.

Next, the glass substrate fragment 80c discharged from the second conveyor portion 90 is housed in the container 93 (S61).

The above-described treatment of feeding the glass substrate fragment 80, detaching and removing an attached member in the first conveyor portion 84, turning over the glass substrate fragment 80 by the turning-over mechanism 88, and performing detachment and removal in the second conveyor portion 90 is performed repeatedly, and thus it is possible to detach and remove an attached member from the glass substrate fragment 80 with excellent productivity, thereby allowing a glass substrate alone to be recovered. Pure glass fragments originating only in the recovered glass substrate can be recycled easily by being remelted.

[3. Effect of Embodiment, etc.]

In the process of handling or conveying a PDP to be disposed of, there is a possibility that a front glass substrate and a back glass substrate that constitute the PDP are damaged or broken. According to the surface removal method and surface removal apparatus of the embodiment of the present invention, even if the PDP 1 already has been damaged or broken prior to a material recovering treatment, it is possible to remove an attached member attached to a glass substrate reliably.

Furthermore, this embodiment uses a configuration in which a blasting treatment is performed with respect to one surface of a glass substrate fragment, the glass substrate fragment is turned over, and then a blasting treatment is performed with respect to the other surface of the glass substrate fragment. Thus, even in the case where when the glass substrate fragments 80 are mounted on the first conveyor portion 84, principal planes of all the glass substrate fragments 80 are not necessarily facing the same direction, the blasting treatment can be performed reliably with respect to front and rear surfaces of all the glass substrate fragments 80, thereby allowing a glass substrate alone to be recovered efficiently.

Furthermore, according to this embodiment, the first blasting nozzle 85 and the second blasting nozzle 91 are disposed in such a manner as to be directed to substantially the same direction, and thus even in the case where the glass substrate fragment 80 mounted on the first conveyor portion 84 and the second conveyor portion 90 is in an irregular shape as a result of crushing, an attached member attached to a surface of a substrate can be removed reliably and efficiently.

Furthermore, according to this embodiment, the first conveyor portion 84 and the second conveyor portion 90 have different configurations from each other, and thus detachment and removal of an attached member can be performed consecutively, thereby allowing a detachment and removal treatment to be performed efficiently.

Although this embodiment uses a configuration in which the first plate body 88a and the second plate body 88b can be moved, any other configuration also is possible as long as it at least allows the glass substrate fragment 80 to be inserted into the turning-over mechanism 88, and the glass substrate fragment 80 that has been inserted therein to be prevented from falling out from the turning-over mechanism 88 when the turning-over mechanism is rotated. For example, a possible configuration includes a mechanism that is capable of opening and dosing an opening on the side of the first conveyor portion 84 and the opening on the side of the second conveyor portion 90 in the turning-over mechanism 88, by which the openings are opened when the glass substrate fragment 80 is inserted into the turning-over mechanism 88, and the openings are closed when the turning-over mechanism 88 is being rotated.

Furthermore, although this embodiment uses a configuration including two conveyor portions (the first conveyor portion 84, the second conveyor portion 90), this embodiment can be realized also by one conveyor portion. This refers to a configuration in which, after a blasting treatment is performed with respect to one surface of a glass substrate fragment mounted on a single conveyor portion, the glass substrate fragment is turned over, and the glass substrate fragment is mounted again on the conveyor portion so that a blasting treatment is performed with respect to the other surface of the glass substrate fragment. This configuration allows the number of conveyor portions to be reduced to one, thereby achieving a cost reduction in plant and equipment spending.

Although the above embodiments have been described using a PDP as an example, similarly in the case of a LCD, it is possible to remove an attached member attached to a glass substrate efficiently. That is, similarly, in a LCD, a front glass substrate to which a color filter, a polarizing filter, a driving member, and the like are attached, and a back glass substrate to which a polarizing filter, a driving member, and the like are attached, are disposed opposite to each other. Therefore, in the case where a LCD is crushed into pieces of an appropriate size, and glass fragments originating in a front plate and a back plate are treated by a similar surface removal method and a similar surface removal apparatus, it is possible to detach and remove an attached member from a glass substrate efficiently, thereby allowing glass fragments made of a glass raw material alone to be obtained.

Furthermore, the steps S2, S12, S21, and S32 of forming glass fragments (glass powder) are examples of the step A. The detachment and removal steps S3, S14, S24, S34, S42, and S45 are examples of the step B. The PDP dividing steps S1, S11, S20, and S40 are examples of the step C. The steps S13, S22, and S30 of forming glass substrate fragments are examples of the step D. The steps S4, S15, S16, S25, S26, S35, S37, S43, and S48 of sorting materials resulting from the detachment and removal treatment into an inorganic powder body and a metal powder body (powder body-sorting step), the steps S5, S17, S28, S38, and S49 of recovering and recycling an inorganic powder body, and the steps S6, S18, S29, S39, and S50 of recovering a noble metal are examples of the step E. The step of inserting the glass substrate fragment 50a into the housing portion 61 is an example of the step F. The step of performing a blasting treatment with respect to the glass substrate fragment 50a in the housing portion 61 is an example of the step G. The steps S52 and S53 of mounting the glass substrate fragment 80 on the first conveyor portion 84 are examples of the step H. The step S54 of performing a blasting treatment with respect to the glass substrate fragment 80 on the first conveyor portion 84 is an example of the step I. The steps S58 and S59 of turning over the glass substrate fragment 80 and mounting it on the second conveyor portion 90 are examples of the step J. The step S60 of performing a blasting treatment with respect to the glass substrate fragment 80 on the second conveyor portion 90 is an example of the step K.

Furthermore, the conveyor portions 42 and 53, the first conveyor portions 73 and 84, and the second conveyor portions 74 and 90 are examples of a substrate-mounting stage. Further, the first conveyor portions 73 and 84 are examples of the first substrate-mounting stage. The second conveyor portions 74 and 90 are examples of the second substrate-mounting stage.

### INDUSTRIAL APPLICABILITY

The present invention provides an apparatus and a method for detaching and removing an attached member attached to a glass substrate. The present invention is useful for, for example, an apparatus and a method for removing a display members and the like attached to a glass substrate mounted in a PDP, a LCD or the like.

1. (canceled)

2. A material recovering method of recovering a front glass substrate and a back glass substrate from a display device comprising: a front plate formed of the front glass substrate on which a front plate display member is formed; and a back plate formed of the back glass substrate on which a back plate display member is formed, in which the front plate and the back plate are disposed opposite to each other, and peripheries of the front plate and the back plate are sealed hermetically with a sealing member so that a space is formed, the method comprising:
a step A of dividing the display device into a first region member that includes the space and a second region member that is other than the first region member;
a step B of crushing the second region member so that a glass fragment is formed; and
a step C of allowing the glass fragment to impact against at least one of the front plate display member and the back plate display member so as to detach and remove the front plate display member from the front glass substrate or so as to detach and remove the back plate display member from the back glass substrate.

3. (canceled)

4. The material recovering method according to claim 2, further comprising: a step D of crushing the first region member so that a glass substrate fragment is formed,
wherein in the step C, the glass fragment formed in the step B and the glass substrate fragment formed in the step D are allowed to impact against each other so as to detach and remove the display members attached to the glass substrate fragment from the glass substrate fragment.

5. The material recovering method according to claim 2, further comprising: a step E of recovering at least one of an inorganic matter and a metal that are contained in the front plate display member or the back plate display member,
wherein the step E is performed subsequent to the step C.

6. A material recovering method in which an attached member attached to at least one surface of a glass substrate is removed from the glass substrate so that the glass substrate is recovered, the method comprising:
a step F of housing the glass substrate in a housing with a side surface provided with a plurality of through holes; and
a step G of performing a blasting treatment with respect to both surfaces of the glass substrate through the plurality of through holes of the housing.

7. The material recovering method according to claim 6,
wherein the housing is disposed at a slant with respect to a perpendicular direction, and
a blast pressure used for a blasting treatment performed from a lower side of a slanting surface of the housing is set to be higher than a blast pressure used for a blasting treatment performed from an upper side of the slanting surface.

8. The material recovering method according to claim 6,
wherein the housing is provided in such a manner as to stand in a perpendicular direction.

9. The material recovering method according to claim 6,
wherein the housing is formed of at least two plate bodies, in each of which a plurality of through holes are formed, and that are disposed opposite to each other via a gap, and
the gap is formed so as to be wider than a thickness of the glass substrate and narrower than twice the thickness of the glass substrate.

10. The material recovering method according to claim 6,
wherein in the step G, at least one of the housing and the glass substrate housed in the housing is swung.

11. A material recovering apparatus that removes an attached member attached to at least one surface of a glass substrate from the glass substrate so as to recover the glass substrate, the apparatus comprising:
a housing with a side surface provided with a plurality of through holes, which can house the glass substrate; and
a blasting device that is capable of performing a blasting treatment with respect to both surfaces of the glass substrate through the plurality of through holes of the housing.

12. The material recovering apparatus according to claim 11,
wherein the housing has a slanting surface that extends from a side from which the housing houses the glass substrate to a side on which the blasting treatment is performed.

13. The material recovering apparatus according to claim 11,
wherein the housing is formed of at least two plate bodies, in each of which a plurality of through holes are formed, and that are disposed opposite to each other via a gap, and
the gap is formed so as to be wider than a thickness of the glass substrate and narrower than twice the thickness of the glass substrate.

14. The material recovering apparatus according to claim 11, further comprising a swinging device that swings at least one of the housing and the glass substrate housed in the housing.

15. A material recovering method in which an attached member attached to at least one surface of a glass substrate is removed from the glass substrate so that the glass substrate is recovered, the method comprising:
a step H of arranging the glass substrate in a single layer on a substrate-mounting stage;
a step I of performing a blasting treatment with respect to one surface of the glass substrate;
a step J of, subsequent to the step I, turning over the glass substrate and arranging the glass substrate in a single layer on the substrate-mounting stage; and
a step K of, subsequent to the step J, performing a blasting treatment with respect to the other surface of the glass substrate,
wherein the step J is a step in which in a state where the glass substrate mounted on a first plate body is held by being sandwiched between the first plate body and a second plate body disposed opposite to the first plate body, a position of the first plate body and a position of the second plate body are reversed.

16. The material recovering method according to claim 15,
wherein each of the step I and the step K is a step in which a blasting treatment is performed with respect to the glass substrate from a side of one of the surfaces of the glass substrate so as to detach and remove the attached member attached to the glass substrate.

17. The material recovering method according to claim 15,
wherein the step H is a step of mounting the glass substrate on a first substrate-mounting stage, and
the step J is a step of mounting the glass substrate on a second substrate-mounting stage.

18. A material recovering apparatus that removes an attached member attached to at least one surface of a glass substrate from the glass substrate so as to recover the glass substrate, the apparatus comprising:
a blasting device that performs a blasting treatment with respect to the glass substrate from a side of one of surfaces of the glass substrate; and
a turning-over mechanism that, after the blasting device has performed the blasting treatment with respect to one surface of the glass substrate, turns over the glass substrate so that the blasting treatment can be performed with respect to the other surface of the glass substrate,
wherein the turning-over mechanism comprises:
a first plate body on which the glass substrate conveyed from a first substrate-mounting stage is mounted;
a second plate body that is disposed opposite to the first plate body;
a clamping mechanism that holds the glass substrate by sandwiching the glass substrate between the first plate body and the second plate body; and
a turning-over portion that reverses a position of the first plate body and a position of the second plate body, while the glass substrate is held by the clamping mechanism.

19. The material recovering apparatus according to claim 18, comprising:
a first substrate-mounting stage that includes a first blasting device and on which a glass substrate is mounted;
a second substrate-mounting stage that includes a second blasting device and on which the glass substrate is mounted; and
a conveyor portion that is capable of conveying the glass substrate from the first substrate-mounting stage to the second substrate-mounting stage,
wherein the turning-over mechanism is provided between the first substrate-mounting stage and the second substrate-mounting stage.

20. The material recovering apparatus according to claim 18,
wherein the first substrate-mounting stage comprises a sorting device that performs sorting of the glass substrate.
